(19) United States
(12) Patent Application Publication
(10) Pub. No.: US 2025/0160332 A1
(43) Pub. Date: May 22, 2025

(54) HERBICIDAL COMBINATIONS AND A METHOD FOR CONTROLLING UNDESIRED VEGETATION

(71) Applicants: UPL MAURITIUS LIMITED, Port Louis (MU); UPL EUROPE LTD, Warrington Cheshire (GB)

(72) Inventors: Giuvan Lenz, São Paolo (BR); Jessica Ferreira Lourenco Leal, São Paolo (BR); Ganesh Rao, Mumbai (IN)

(21) Appl. No.: 18/867,767

(22) PCT Filed: May 23, 2023
(86) PCT No.: PCT/IB2023/055268

§ 371 Date: Nov. 20, 2024

(30) Foreign Application Priority Data
May 23, 2022 (IN) 202211029600

(51) Int. Cl. A01N 57/20; A01N 39/04; A01N 41/10; A01N 43/40; A01N 43/54; A01N 43/56; A01N 43/60; A01P 13/00

(52) U.S. Cl. CPC A01N 57/20; A01N 39/04; A01N 41/10; A01N 43/40; A01N 43/54; A01N 43/56; A01N 43/60; A01P 13/00

(57) ABSTRACT

The present disclosure relates to a method for controlling unwanted vegetation/weeds. More particularly, the present disclosure relates to a method for controlling Amaranthus genus weeds with synergistic herbicidal combinations comprising L-glufosinate, salts, esters, or combinations thereof and at least one additional herbicide.

### FIELD OF THE DISCLOSURE

The present disclosure relates to a method of controlling undesired vegetation/weeds. More particularly, the present disclosure relates to a method of controlling Amaranthus genus weeds with synergistic herbicidal combinations and compositions of said combinations.

### BACKGROUND OF THE DISCLOSURE

Weeds are undesirable plants that are detrimental to agriculture and significantly affect crop yields. Farmers use various types of herbicides to control the weeds. Herbicides are chemical substances, which are used to specifically control the unwanted plants/weeds.

Amaranthus is a cosmopolitan genus of annual or short-lived perennial plants collectively known as amaranths. Also, known as pigweed, there are about seventy species in this cosmopolitan genus Amaranthus of herbaceous plants. Amaranthus hybridus species is known as smooth pigweed. Amaranthus hybridus is a species in the family Amaranthaceae. It is found in America, Africa, south-central Asia and Australia. Amaranthus viridis is another species in the family Amaranthaceae. It is found in different regions such as Africa, Asia, Europe, North America, Oceania and South America.

There are certain species of unwanted plants/weeds or groups of unwanted plants/weeds, which are not susceptible to certain herbicides. This may be because the herbicides use different biochemical pathways. In situations, when one herbicide is ineffective, another herbicide with a different mode of action may provide better results. For this reason, there is a constant need to develop effective herbicidal combinations to control the growth of unwanted plants/weeds. The herbicides, solo or combinations, presently known in the art are not sufficient to control resistant and persistent Amaranthus genus weeds such as Amaranthus hybridus or Amaranthus viridis.

Furthermore, selective control of unwanted plants/weeds in crops is a key challenge facing modern agriculture. Additionally, the herbicides may not always provide the desired effect. Combinations of herbicides may sometimes result in an additive effect or an antagonistic effect. It may also result in phytotoxicity to the crops making it an undesirable combination. Consequently, herbicides need to be carefully selected so that they can be combined to offer a synergistic effect that would control weeds while having no phytotoxic effect on the crop and reduce the chances of the weeds developing resistance to a particular herbicide.

Therefore, there is a need in the art for a method of protecting crops from Amaranthus genus weeds using herbicidal combinations that have advantageous properties such as being synergistic, helping in resistance management, reducing dosage of herbicides used and providing improved residual effects.

### OBJECTIVES OF THE DISCLOSURE

It is a primary objective of the present disclosure to provide a method of controlling Amaranthus genus weeds by applying a synergistic herbicidal combination.

It is another objective of the present disclosure to provide a method of controlling Amaranthus genus weeds, by applying a synergistic herbicidal combination comprising L-glufosinate, salts, esters, or combinations thereof, and at least one additional herbicide.

It is yet another objective of the present disclosure to provide a method of controlling Amaranthus genus weeds, by applying a synergistic herbicidal combination comprising L-glufosinate, salts, esters, or combinations thereof, and at least one additional herbicide selected from the group comprising protoporphyrinogen oxidase inhibitor herbicides, acetyl coenzyme A (CoA) carboxylase inhibitor herbicides, auxin mimics herbicide, acetolactate synthase inhibitor herbicides, hydroxyphenyl pyruvate dioxygenase inhibitor herbicides, or combinations thereof.

It is yet another objective of the present disclosure to provide a method of controlling Amaranthus genus weeds, by applying a synergistic herbicidal combination comprising L-glufosinate, salts, esters, or combinations thereof, and at least one additional herbicide selected from the group comprising protoporphyrinogen oxidase inhibitor herbicides, auxin mimics herbicides, or combinations thereof.

It is yet another objective of the present disclosure to provide a method of controlling Amaranthus genus weeds, by applying a synergistic herbicidal combination comprising L-glufosinate, salts, esters, or combinations thereof, and at least two additional herbicides selected from the group comprising acetolactate synthase inhibitor herbicide, or combinations thereof.

It is yet another objective of the present disclosure to provide a method of controlling Amaranthus genus weeds in plants, wherein the method comprises applying a synergistic herbicidal combination comprising L-glufosinate, salts, esters, or combinations thereof, and at least one additional herbicide to a plant or a locus thereof, where undesirable vegetation occurs or is expected to occur.

It is yet another objective of the present disclosure to provide a method of increasing yield in a plant by application of a synergistic herbicidal combination.

It is yet another objective of the present disclosure to provide a method of improving the plant health by application of a synergistic herbicidal combination.

### SUMMARY OF DISCLOSURE

In an aspect, there is provided a synergistic herbicidal combination for control of Amaranthus genus weeds, said combination comprising L-glufosinate, salts, esters, or combinations thereof and at least one additional herbicide.

In another aspect, there is provided a synergistic herbicidal combination for control of Amaranthus genus weeds, said combination comprising L-glufosinate, salts, esters, or combinations thereof and at least one additional herbicide selected from the group comprising:
(a) protoporphyrinogen oxidase inhibitor herbicides;
(b) acetyl CoA carboxylase inhibitor herbicides;
(c) auxin mimics herbicides;
(d) acetolactate synthase inhibitor herbicides;
(e) hydroxyphenyl pyruvate dioxygenase inhibitor herbicides;
or combinations thereof.

In another aspect, there is provided a synergistic herbicidal combination for control of Amaranthus genus weeds, the combination comprising:
(a) L-glufosinate, salts, esters, or combinations thereof;
(b) at least one protoporphyrinogen oxidase inhibitor herbicide; and
(c) at least one auxin mimics herbicide.

In another aspect, there is provided a synergistic herbicidal combination for control of Amaranthus genus weeds, the combination comprising:
(a) L-glufosinate, salts, esters, or combinations thereof; and
(b) at least two acetolactate synthase inhibitor herbicide.

In another aspect, there is provided a synergistic herbicidal composition for controlling Amaranthus genus weeds, wherein the composition comprises:
(a) L-glufosinate, salts, esters, or combinations thereof; and
(b) at least one additional herbicide selected from the group comprising
   protoporphyrinogen oxidase inhibitor herbicides, acetyl CoA carboxylase inhibitor herbicides, auxin mimics herbicides, acetolactate synthase inhibitor herbicides, hydroxyphenyl pyruvate dioxygenase inhibitor herbicides, or combinations thereof; and
(c) at least one agrochemically acceptable excipient.

In another aspect, there is provided a synergistic herbicidal composition for controlling Amaranthus genus weeds, wherein the composition comprises:
(a) L-glufosinate, salts, esters, or combinations thereof;
(b) at least one protoporphyrinogen oxidase inhibitor herbicide;
(c) at least one auxin mimics herbicide; and
(d) at least one agrochemically acceptable excipient.

In another aspect, there is provided a synergistic herbicidal combination for control of Amaranthus genus weeds, the combination comprising:
(a) L-glufosinate, salts, esters, or combinations thereof;
(b) at least two acetolactate synthase inhibitor herbicide; and
(c) at least one agrochemically acceptable excipient.

In an aspect, the present disclosure provides a method of controlling Amaranthus genus weeds, said method comprising applying to a plant or a locus thereof at which control is desired, a synergistic herbicidal combination comprising L-glufosinate, salts, esters, or combinations thereof and at least one additional herbicide.

In another aspect, there is provided a method of controlling Amaranthus genus weeds, said method comprising applying to a plant or a locus thereof at which control is desired, a synergistic herbicidal combination comprising:
(a) L-glufosinate, salts, esters, or combinations thereof; and
(b) at least one additional herbicide selected from the group comprising: at least one protoporphyrinogen oxidase inhibitor herbicide, at least one acetyl CoA carboxylase inhibitor herbicide, at least one auxin mimics herbicide, at least one acetolactate synthase inhibitor herbicides, at least one hydroxyphenyl pyruvate dioxygenase inhibitor herbicides, or combinations thereof.

### DETAILED DESCRIPTION OF DISCLOSURE

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. Hence, the following descriptions are intended to illustrate some particular embodiments of the disclosure, and not to exhaustively specify all permutations, combinations and variations thereof.

For the purposes of the following detailed description, it is to be understood that the disclosure may assume various alternative variations except where expressly specified to the contrary. Moreover, other than in any operating examples, or where otherwise indicated, all numbers expressing, for example, quantities of materials/ingredients used in the specification are to be understood as being modified in all instances by the term “about”. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value.

Unless otherwise defined, all technical and scientific terms used herein have the same meaning as commonly understood by one of ordinary skill in the art to which this disclosure pertains. In the case of conflict, the present document, including definitions will control. Although methods and materials similar or equivalent to those described herein can be used in the practice or testing of the disclosure, suitable methods and materials are described herein.

It is to be noted that, as used in the specification, the singular forms “a”, “an”, and “the” include both singular and plural referents, unless the context clearly dictates otherwise.

The expression of various quantities in terms of “%” or “% w/w” means the percentage by weight of the total solution or composition unless otherwise specified.

The terms “comprising”, “having”, “including”, and “containing” are to be construed as open-ended terms (i.e., meaning “including, but not limited to”) unless otherwise noted.

The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

The term “herbicide” as used herein denotes a compound which controls or modifies the growth of undesired weeds.

The term “herbicidally effective amount” indicates the quantity of such a compound or combination of such compounds which is capable of controlling or modifying effect on the growth of harmful plants/undesired vegetation/weeds. Controlling effects include all deviation from natural development, for example: killing, retardation, leaf burn, albinism, dwarfing etc.

The term “plants” refers to all physical parts of a plant, including seeds, seedlings, saplings, roots, tubers, stems, stalks, foliage and fruits.

The term “locus” refers to an area of planted crops or a location where Amaranthus genus weeds occurs or grows or can occur or grow and is intended to include soil, medium of growth other than soil.

As used herein, the terms “undesirable vegetation”, “undesirable species”, “undesirable plants”, “harmful plants”, “undesirable weeds”, “harmful weeds”, “unwanted plants”, “weed(s)” are synonyms.

The terms “g a.i./L” as used herein denotes the concentration of the respective active ingredient in “grams” present “per litre” of the composition. The terms “g a.i./L” and “g ai/L” and “g/L” may be used interchangeably throughout the disclosure.

The terms “g a.i./ha” as used herein denotes the concentration of the respective active ingredient in “grams” applied “per hectare” of the crop field.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other fungicides or insecticide or plant growth promoting agents, adjuvants, or excipients not specifically recited therein.

The term “control” relates to a weed, includes control of the weed, as well as protecting a plant, a portion of the plant, or a plant seed from attack or invasion by said weed.

As used herein, the term “pre-emergence” or “before emergence” refers to the time point before seedlings emerge from the ground. When any herbicide is applied at pre-emergence stage, it prevents establishment of the germinated weed seedlings.

As used herein, the term “post-emergence” refers to the time point after seedlings emerge from the ground. When any herbicide is applied at post-emergence stage, it prevents growth of the germinated weed seedlings.

Glufosinate (also known as phosphinothricin; DL-homoalanin-4-yl(methyl)phosphinic acid) is a non-proteinogenic alpha-amino acid that is 2-aminobutanoic acid which is substituted at position 4 by a hydroxy(methyl)phosphoryl group. It is a member of phosphinic acids and a non-proteinogenic alpha-amino acid. Its ammonium salt (glufosinate-ammonium) is widely used as a non-selective herbicide and is the active ingredient of various commercial herbicide formulations. Glufosinate has two optical isomers, namely, L-isomer and D-isomer, of which, the L-isomer possesses high efficiency while the D-isomer is inactive. In addition, L-glufosinate is more environment friendly, thereby reducing the use of pesticides and increasing the efficiency of pesticide application. The L-isomer of glufosinate is a structural analogue of glutamate and, therefore, is a competitive inhibitor of the enzyme glutamine synthetase (GS) of bacteria and plants (Bayer et al, 1972, Phosphinothricin and phosphinothricyl-alanyl-alanin. Helv. Chim. Acta 55, 224-239; Leason et al., 1982, Inhibition of pea leaf glutamine synthetase by methioninsulfoximine, Phosphinothricin and other glutamate analogs. J. Phytochem. 21, 855-857). The chemical structures of D-glufosinate and L-glufosinate are represented as below.

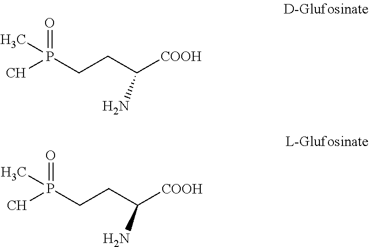

As used herein, the term “glufosinate” refers to any molecule which is a racemic phosphinico amino acid. The term also includes salts, forms such as solvates, hydrates, anhydrous form, crystalline form, polymorph forms, pseudo polymorph forms, amorphous forms, or mixtures thereof, and sodium, potassium or ammonium salts. The salts of glufosinate such as monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, and —NH₂(CH₃)(C₂H₄OH)⁺ salt are included in the definition. The agrochemically acceptable salts include Glufosinate-ammonium, Glufosinate-sodium, Glufosinate-potassium, or combinations thereof.

As used herein, the term “L-glufosinate” includes the L-isomer of Glufosinate, a salt and an ester thereof. The L-enantiomer of glufosinate acts by inhibition of glutamine synthetase thereby causing accumulation of toxic levels of ammonium ion and indirectly inhibiting photosynthesis. It is also known as phosphinothricin or (S)-2-amino-4-(hydroxy(methyl)phosphonoyl)butanoic acid. The term can generically refer to any form of L-glufosinate such as solvates, hydrates, esters, anhydrous form, polymorph forms, pseudo polymorph forms, amorphous forms, or mixtures thereof, and sodium, potassium or ammonium salts. The salts of L-glufosinate such as monosodium salt, disodium salt, monopotassium salt, dipotassium salt, calcium salt, ammonium salt, —NH3(CH3)+ salt, —NH2(CH3)2+ salt, —NH(CH3)3+ salt, —NH(CH3)2(C2H4OH)+ salt, and —NH2(CH3)(C2H₄OH)+ salt are included in the definition. The agrochemically acceptable salts include L-glufosinate-ammonium, L-glufosinate-sodium, L-glufosinate-potassium, or combinations thereof. The term may also refer to an isomeric (racemic) mixture of L-glufosinate, D-glufosinate and salts thereof, wherein the content of L-glufosinate in the mixture is 70% or greater, preferably 80% or greater, and more preferably 90% or greater. Typically, the ratio of L-glufosinate to D-glufosinate can be in a range from about 90:10 to about 99.9:0.1, preferably from about 95:5 to about 99.9:0.1.

As used herein, the term “Amaranthus genus weeds” means all the species falling within genus Amaranthus in the family Amaranthaceae and include species such as Amaranthus acanthochiton, Amaranthus acutilobus, Amaranthus albus, Amaranthus anderssonii, Amaranthus arenicola, Amaranthus australis, Amaranthus bigelovii, Amaranthus blitoides, Amaranthus blitum, Amaranthus brownie, Amaranthus californicus, Amaranthus cannabinus, Amaranthus caudatus, Amaranthus chihuahuensis, Amaranthus crassipes, Amaranthus crispus, Amaranthus cruentus, Amaranthus deflexus, Amaranthus dubius, Amaranthus fimbriatus, Amaranthus floridanus, Amaranthus furcatus, Amaranthus graecizans, Amaranthus grandifloras, Amaranthus greggii, Amaranthus hybridus, Amaranthus hypochondriacus, Amaranthus interruptus, Amaranthus minimus, Amaranthus mitchellii, Amaranthus muricatus, Amaranthus obcordatus, Amaranthus palmeri, Amaranthus polygonoides, Amaranthus powellii, Amaranthus pringlei, Amaranthus pumilus, Amaranthus quitensis, Amaranthus retroflexus, Amaranthus saradhiana, Amaranthus scleranthoides, Amaranthus scleropoides, Amaranthus spinosus, Amaranthus standleyanus, Amaranthus thunbergia, Amaranthus torreyi, Amaranthus tricolor, Amaranthus tuberculatus, Amaranthus viridis, Amaranthus watsonii, Amaranthus wrightii, or combinations thereof.

Discussed below are some representative embodiments of the present disclosure. The disclosure in its broader aspects is not limited to the specific details and representative methods. Illustrative examples are described in this section in connection with the embodiments and methods provided.

An effective weed control can be achieved by usage of herbicides appropriately. The activity of herbicides can be enhanced in various ways to achieve the maximum benefit. One of the ways is to use herbicides with different herbicidal combinations. However, identifying appropriate combinations, their agrochemical application rates, and ratio of the combinations is essential to achieve efficacious control, which is not straight forward.

Accordingly, the present disclosure provides a method for partially or completely controlling harmful weeds with a combination of two or more herbicides.

Accordingly, the present disclosure provides a method for partially or completely controlling harmful weeds with a herbicidal combination.

Accordingly in an embodiment, the present disclosure provides a herbicidal combination.

In another embodiment, the present disclosure provides a herbicidal combination comprising L-glufosinate, salts, esters, or combinations thereof and at least one additional herbicide.

As used throughout the disclosure, L-glufosinate and the additional herbicide, includes their salts, esters, ethers, polymorphs including solvates and hydrates. A salt includes salts that retain the biological effectiveness and properties of the active ingredient, and which are not biologically or otherwise undesirable, and include derivatives of the disclosed compounds in which the parent compound is modified by making inorganic and organic, non-toxic, acid or base addition salts thereof. The salts can be synthesized from the parent compound by conventional chemical methods.

It has been found by the inventors of the present invention that Amaranthus genus weeds can be completely controlled using a herbicidal combination comprising L-glufosinate, salts, esters, or combinations thereof, and at least one additional herbicide selected from the group comprising:
(a) protoporphyrinogen oxidase inhibitor herbicides;
(b) acetyl CoA carboxylase inhibitor herbicides;
(c) auxin mimics herbicides;
(d) acetolactate synthase inhibitor herbicides;
(e) hydroxyphenyl pyruvate dioxygenase inhibitor herbicides;
or combinations thereof.

It was found that in present combinations, L-glufosinate, salts, esters, or combinations thereof and the additional herbicide, provided a synergistic effect in controlling Amaranthus genus weeds. The degree of synergistic enhancement in the efficacy of the above combinations towards control of Amaranthus genus weeds was unpredictable and unexpected. Moreover, the properties and advantages mentioned are required in practical weed control in order to keep agricultural crops free from unwanted competing plants, and thus to qualitatively and quantitatively ensure and/or increase the yield in a plant.

Accordingly, the present disclosure provides a method for partially or completely controlling harmful weeds with a synergistic herbicidal combination.

Accordingly, the present disclosure provides a method for partially or completely controlling Amaranthus genus weeds with a synergistic herbicidal combination.

Accordingly in an embodiment, the present disclosure provides a synergistic herbicidal combination.

In another embodiment, the present disclosure provides a synergistic herbicidal combination comprising L-glufosinate, salts, esters, or combinations thereof and at least one additional herbicide.

The present disclosure, therefore, in an embodiment, provides, a synergistic herbicidal combination for controlling Amaranthus genus weeds, wherein the combination comprises L-glufosinate, salts, esters, or combinations thereof and at least one additional herbicide selected from the group comprising:
(a) protoporphyrinogen oxidase inhibitor herbicides;
(b) acetyl CoA carboxylase inhibitor herbicides;
(c) auxin mimics herbicides;
(d) acetolactate synthase inhibitor herbicides;
(e) hydroxyphenyl pyruvate dioxygenase inhibitor herbicides;
or combinations thereof.

In an embodiment, the salt of L-glufosinate is selected from the group comprising L-glufosinate sodium, L-glufosinate potassium, L-glufosinate ammonium, or combinations thereof. The salts of L-glufosinate can be selected from the group comprising monosodium salt, disodium salt, monopotassium salt, dipotassium salt, calcium salt, ammonium salt, —NH₃(CH₃)⁺ salt, —NH₂(CH₃)²⁺ salt, —NH(CH₃)³⁺ salt, —NH(CH₃)₂(C₂H₄OH)⁺ salt, —NH₂(CH₃)(C₂H₄OH)⁺ salt, or combinations thereof.

In an embodiment, the salt of L-glufosinate is L-glufosinate ammonium.

In an embodiment the salt of L-glufosinate is L-glufosinate sodium.

In an embodiment, the salt of L-glufosinate is L-glufosinate potassium.

In another embodiment, the present disclosure provides a herbicidal combination comprising L-glufosinate ammonium and at least one additional herbicide.

In another embodiment, the present disclosure provides a synergistic herbicidal combination comprising L-glufosinate ammonium and at least one additional herbicide.

In another embodiment, the present disclosure provides a synergistic herbicidal combination for controlling Amaranthus genus weeds, wherein the combination comprises L-glufosinate ammonium and at least one additional herbicide selected from the group comprising:
(a) protoporphyrinogen oxidase inhibitor herbicides;
(b) acetyl CoA carboxylase inhibitor herbicides;
(c) auxin mimics herbicides;
(d) acetolactate synthase inhibitor herbicides;
(e) hydroxyphenyl pyruvate dioxygenase inhibitor herbicides;
or combinations thereof.

In an embodiment, the protoporphyrinogen oxidase inhibitor herbicide is selected from one or more of below listed herbicides or their salts, esters, isomers and combinations thereof.

TABLE 1
Protoporphyrinogen oxidase inhibitor herbicides

| | Chemical Class of | Protoporphyrinogen |
|---|---|---|
| | protoporphyrinogen oxidase | oxidase inhibitor |
| Sr. No. | inhibitor herbicides | herbicides |
| 1. | Diphenyl ethers | Acifluorfen |
| 2. | | Bifenox |
| 3. | | Chlomethoxyfen |
| 4. | | Chlornitrofen |
| 5. | | Fluorodifen |
| 6. | | Fluoroglycofen |
| 7. | | Fluoronitrofen |
| 8. | | Fomesafen |
| 9. | | Lactofen |
| 10. | | Nitrofen |
| 11. | | Oxyfluorfen |
| 12. | N-Phenyl-imides | Butafenacil |
| 13. | | Chlorphthalim |
| 14. | | Cinidon-ethyl |
| 15. | | Epyrifenacil |
| 16. | | Flumiclorac-pentyl |
| 17. | | Flumioxazin |
| 18. | | Flumipropyn |
| 19. | | Pentoxazone |
| 20. | | Saflufenacil |
| 21. | | Tiafenacil |
| 22. | | Trifludimoxazin |
| 23. | | Fluthiacet-methyl |
| 24. | N-Phenyl-oxadiazolones | Oxadiargyl |
| 25. | | Oxadiazon |
| 26. | N-Phenyl-triazolinones | Azafenidin |
| 27. | | Carfentrazone-ethyl |
| 28. | Phenylpyrazoles | Pyraflufen-ethyl |
| 29. | Unclassified herbicides | Pyraclonil |

In an embodiment, the auxin mimics herbicide is selected from one or more of below listed herbicides or their salts, esters, isomers and combinations thereof.

TABLE 2
Auxin mimics herbicides

| | Chemical Class of auxin | |
|---|---|---|
| Sr. No. | mimics herbicides | Auxin mimics herbicides |
| 1. | Benzoates/Benzoic | Chloramben |
| 2. | acids | Dicamba |
| 3. | | 2,3,6-Trichlorobenzoic |
| | | acid (TBA) |
| 4. | Phenoxy- | 2,4,5- |
| | carboxylates/ | Trichlorophenoxyacetic |
| | Phenoxypropionics | acid (T) |
| 5. | | 2,4-Dichlorophenoxyacetic |
| | | acid (D) |
| 6. | | 2,4-Dichlorophenoxyacetic |
| | | acid (DB) |
| 7. | | Clomeprop |
| 8. | | Dichlorprop |
| 9. | | Fenoprop |
| 10. | | 2-methyl-4- |
| | | chlorophenoxyacetic |
| | | acid (MCPA) |
| 11. | | 4-(4-chloro-o- |
| | | tolyloxy)butyric acid |
| | | (MCPB) |
| 12. | | Mecoprop |
| 13. | Phenylcarboxylic acids | Chlorfenac |
| 14. | | Chlorfenprop |
| 15. | Pyridine- | Aminopyralid |
| 16. | carboxylates/ | Clopyralid |
| 17. | Pyridinecarboxylic | Florpyrauxifen |
| 18. | acids | Halauxifen |
| 19. | | Picloram |
| 20. | Pyridyloxy- | Fluroxypyr |
| 21. | carboxylates/ | Triclopyr |
| | Pyridyloxycarboxylic acids | |
| 22. | Pyrimidine- | Aminocyclopyrachlor |
| | carboxylates/ | |
| | Pyrimidinecarboxylic acids | |
| 23. | Quinoline- | Quinmerac |
| | carboxylates/ | |
| | Quinolinecarboxylic acids | |
| 24. | Unclassified herbicides | Benazolin-ethyl |

In an embodiment, the acetyl CoA carboxylase inhibitor herbicide is selected from one or more of below listed herbicides or their salts, esters, isomers and combinations thereof.

TABLE 3
Acetyl CoA carboxylase inhibitor herbicides

| | Chemical Class of acetyl CoA | Acetyl CoA carboxylase |
|---|---|---|
| Sr. No. | carboxylase inhibitor herbicides | inhibitor herbicides |
| 1. | Aryloxyphenoxy- | Clodinafop-propargyl |
| 2. | propionates/ | Clofop |
| 3. | Aryloxyphenoxypropionics | Cyhalofop-butyl |
| 4. | | Diclofop-methyl |
| 5. | | Fenoxaprop-ethyl |
| 6. | | Fenthiaprop |
| 7. | | Fluazifop-butyl |
| 8. | | Haloxyfop |
| 9. | | Isoxapyrifop |
| 10. | | Metamifop |
| 11. | | Quizalofop-ethyl |
| 12. | | Quizalofop-P-tefuryl |
| 13. | Cyclohexanediones/ | Alloxydim |
| 14. | Cyclohexanedione | Butroxydim |
| 15. | oximes | Clethodim |
| 16. | | Cloproxydim |
| 17. | | Cycloxydim |
| 18. | | Profoxydim |
| 19. | | Sethoxydim |
| 20. | | Tepraloxydim |
| 21. | | Tralkoxydim |
| 22. | Phenylpyrazolines | Pinoxaden |

In an embodiment, acetolactate synthase inhibitor herbicide is selected from one or more of below listed herbicides or their salts, esters, isomers and combinations thereof.

TABLE 4
Acetolactate synthase inhibitor herbicides

| | Chemical Class of acetolactate | Acetolactate synthase |
|---|---|---|
| Sr. No. | synthase inhibitor herbicides | inhibitor herbicides |
| 1. | Imidazolinones | Imazamethabenz-methyl |
| 2. | | Imazamox |
| 3. | | Imazapic |
| 4. | | Imazapyr |
| 5. | | Imazaquin |
| 6. | | Imazethapyr |
| 7. | Pyrimidinyl | Bispyribac-sodium |
| 8. | benzoates | Pyribenzoxim (prodrug |
| | | of bispyribac) |
| 9. | | Pyriftalid |
| 10. | | Pyriminobac-methyl |
| 11. | | Pyrithiobac-sodium |
| 12. | Sulfonanilides | Pyrimisulfan |
| 13. | | Triafamone |
| 14. | Sulfonylureas | Amidosulfuron |
| 15. | | Azimsulfuron |
| 16. | | Bensulfuron-methyl |
| 17. | | Chlorimuron-ethyl |
| 18. | | Chlorsulfuron |
| 19. | | Cinosulfuron |
| 20. | | Cyclosulfamuron |
| 21. | | Ethametsulfuron-methyl |
| 22. | | Ethoxysulfuron |
| 23. | | Flazasulfuron |
| 24. | | Flucetosulfuron |
| 25. | | Flupyrsulfuron-methyl- |
| | | sodium |
| 26. | | Foramsulfuron |
| 27. | | Imazosulfuron |
| 28. | | Iodosulfuron-methyl- |
| | | sodium |
| 29. | | Mesosulfuron-methyl |
| 30. | | Metazosulfuron |
| 31. | | Metsulfuron-methyl |
| 32. | | Nicosulfuron |
| 33. | | Orthosulfamuron |
| 34. | | Oxasulfuron |
| 35. | | Primisulfuron-methyl |
| 36. | | Propyrisulfuron |
| 37. | | Prosulfuron |
| 38. | | Pyrazosulfuron-ethyl |
| 39. | | Rimsulfuron |
| 40. | | Sulfometuron-methyl |
| 41. | | Sulfosulfuron |
| 42. | | Thifensulfuron-methyl |
| 43. | | Triasulfuron |
| 44. | | Tribenuron-methyl |
| 45. | | Trifloxysulfuron- |
| | | sodium |
| 46. | | Triflusulfuron-methyl |
| 47. | | Tritosulfuron |
| 48. | Triazolinones/ | Flucarbazone- |
| | Sulfonylaminocarbonyltriazolinones | sodium |
| 49. | | Propoxycarbazone- |
| | | sodium |
| 50. | | Thiencarbazone-methyl |
| 51. | Triazolopyrimidine - | Cloransulam-methyl |
| 52. | Type 1/Triazolopyrimidines | Diclosulam |
| 53. | | Florasulam |
| 54. | | Flumetsulam |
| 55. | | Metosulam |
| 56. | Triazolopyrimidine - | Penoxsulam |
| 57. | Type 2/Triazolopyrimidines | Pyroxsulam |

In an embodiment, hydroxyphenyl pyruvate dioxygenase herbicide is selected from one or more of below listed herbicides or their salts, esters, isomers and combinations thereof.

TABLE 5
Hydroxyphenyl pyruvate dioxygenase herbicides

| | Chemical Class of Hydroxyphenyl | Hydroxyphenyl |
|---|---|---|
| | Pyruvate Dioxygenase | Pyruvate Dioxygenase |
| Sr. No. | inhibitor herbicides | inhibitor herbicides |
| 1. | Isoxazoles | Isoxaflutole |
| 2. | Pyrazoles | Pyrasulfotole |
| 3. | | Tolpyralate |
| 4. | | Topramezone |
| 5. | | Benzofenap |
| 6. | | Pyrazolynate |
| 7. | | Pyrazoxyfen |
| 8. | Triketones | Bicyclopyrone |
| 9. | | Fenquinotrione |
| 10. | | Mesotrione |
| 11. | | Sulcotrione |
| 12. | | Tefuryltrione |
| 13. | | Tembotrione |
| 14. | | Benzobicyclon |

In an embodiment, the present disclosure provides a synergistic herbicidal combination comprising:
(a) the protoporphyrinogen oxidase inhibitor herbicide is saflufenacil;
(b) the acetyl CoA carboxylase inhibitor herbicide is selected from the group comprising quizalofop-ethyl, quizalofop-p-tefuryl, or combinations thereof;
(c) the auxin mimics herbicide is selected from the group comprising 2,4-D choline, triclopyr, or combinations thereof;
(d) the acetolactate synthase inhibitor herbicide is selected from the group comprising imazapic, imazapyr, or combinations thereof; and
(e) the hydroxyphenyl pyruvate dioxygenase inhibitor herbicide is mesotrione.

In an embodiment, the present disclosure provides a synergistic herbicidal combination comprising L-glufosinate, salts, esters, or combinations thereof and at least one protoporphyrinogen oxidase inhibitor herbicide for controlling Amaranthus genus weeds.

In a preferred embodiment, the protoporphyrinogen oxidase inhibitor herbicide is saflufenacil.

In an embodiment, the present disclosure provides a synergistic herbicidal combination comprising L-glufosinate, salts, esters, or combinations thereof and saflufenacil for controlling Amaranthus genus weeds.

In an embodiment, the present disclosure provides a synergistic herbicidal combination comprising L-glufosinate ammonium and saflufenacil for controlling Amaranthus genus weeds.

In an embodiment, the combination further comprises at least one auxin mimics herbicide.

Accordingly, there is provided a synergistic herbicidal combination for control of Amaranthus genus weeds comprising L-glufosinate, salts, esters, or combinations thereof, at least one protoporphyrinogen oxidase inhibitor herbicide and at least one auxin mimics herbicide.

In an embodiment, the auxin mimics herbicide is 2,4-D.

In an embodiment, the auxin mimics herbicide is a quaternary ammonium salt of 2,4-D, which results from the reaction of 2,4-D with choline.

In a preferred embodiment, the auxin mimics herbicide is 2,4-D choline.

In an embodiment, the auxin herbicide is triclopyr.

In an embodiment, the present disclosure provides a synergistic herbicidal combination comprising L-glufosinate, salts, esters, or combinations thereof, saflufenacil and 2,4-D choline for controlling Amaranthus genus weeds.

In an embodiment the present disclosure provides a synergistic herbicidal combination comprising L-glufosinate ammonium, saflufenacil and 2,4-D choline for controlling Amaranthus genus weeds.

In an embodiment, the present disclosure provides a synergistic herbicidal combination comprising L-glufosinate, salts, esters, or combinations thereof, saflufenacil and triclopyr for controlling Amaranthus genus weeds.

In an embodiment, the present disclosure provides a synergistic herbicidal combination comprising L-glufosinate ammonium, saflufenacil and triclopyr for controlling Amaranthus genus weeds.

Accordingly, there is provided a synergistic herbicidal combination comprising L-glufosinate, salts, esters, or combinations thereof and at least one acetyl CoA carboxylase inhibitor herbicide for controlling Amaranthus genus weeds.

In an embodiment, the acetyl CoA carboxylase inhibitor herbicide is quizalofop-ethyl.

In an embodiment, the acetyl CoA carboxylase inhibitor herbicide is quizalofop-p-tefuryl.

In an embodiment, the present disclosure provides a synergistic herbicidal combination comprising L-glufosinate, salts, esters, or combinations thereof and quizalofop-ethyl for controlling Amaranthus genus weeds.

In an embodiment, the present disclosure provides a synergistic herbicidal combination comprising L-glufosinate ammonium and quizalofop-ethyl for controlling Amaranthus genus weeds.

In an embodiment, the present disclosure provides a synergistic herbicidal combination comprising L-glufosinate, salts, esters, or combinations thereof and quizalofop-p-tefuryl for controlling Amaranthus genus weeds.

In an embodiment, the present disclosure provides a synergistic herbicidal combination comprising L-glufosinate ammonium and quizalofop-p-tefuryl for controlling Amaranthus genus weeds.

Accordingly, there is provided a synergistic herbicidal combination for control of Amaranthus genus weeds comprising L-glufosinate, salts, esters, or combinations thereof and at least one acetolactate synthase inhibitor herbicide.

In an embodiment, the acetolactate synthase inhibitor herbicide is a combination of Imazapic and Imazapyr.

In an embodiment, the present disclosure provides a synergistic herbicidal combination comprising L-glufosinate, salts, esters, or combinations thereof, Imazapic and Imazapyr for controlling Amaranthus genus weeds.

In an embodiment, the present disclosure provides a synergistic herbicidal combination comprising L-glufosinate ammonium, Imazapic and Imazapyr for controlling Amaranthus genus weeds.

Accordingly, there is provided a synergistic herbicidal combination comprising L-glufosinate, salts, esters, or combinations thereof and at least one hydroxyphenyl pyruvate dioxygenase inhibitor herbicides for control of Amaranthus genus weeds.

In an embodiment, the hydroxyphenyl pyruvate dioxygenase inhibitor herbicide is mesotrione.

In an embodiment, the present disclosure provides a synergistic herbicidal combination comprising L-glufosinate, salts, esters, or combinations thereof and mesotrione for controlling Amaranthus genus weeds.

In an embodiment, the present disclosure provides a synergistic herbicidal combination comprising L-glufosinate ammonium and mesotrione for controlling Amaranthus genus weeds.

In an embodiment, the present disclosure provides a herbicidal combination comprising:
(a) L-glufosinate, salts, esters, or combinations thereof;
(b) at least one additional herbicide selected from the group comprising protoporphyrinogen oxidase inhibitor herbicide, or combinations thereof;
   or
(b) at least two additional herbicides selected from the group comprising acetolactate synthase inhibitor herbicide.

In an embodiment, the combination further comprises at least one additional herbicide selected from the group comprising auxin mimics herbicide, or combinations thereof.

In an embodiment, the present disclosure provides a method for controlling weeds by applying a herbicidal combination comprising:
(a) L-glufosinate, salts, esters, or combinations thereof; and
(b) at least one additional herbicide selected from the group comprising protoporphyrinogen oxidase inhibitor herbicides; acetyl CoA carboxylase inhibitor herbicides; auxin mimics herbicides; acetolactate synthase inhibitor herbicides; hydroxyphenyl pyruvate dioxygenase inhibitor herbicides; or combinations thereof; wherein the weeds comprise Amaranthus genus weeds.

In an embodiment, the present disclosure provides a synergistic herbicidal combination for control of Amaranthus genus weeds, the combination comprising L-glufosinate, salts, esters, or combinations thereof and at least one additional herbicide, wherein a weight ratio of L-glufosinate, salts, esters, or combinations thereof and at least one additional herbicide ranges from about 1:100 to about 100:1.

In an embodiment, the present disclosure provides a synergistic herbicidal combination for control of Amaranthus genus weeds, the combination comprising L-glufosinate ammonium and at least one additional herbicide, wherein a weight ratio of L-glufosinate ammonium and at least one additional herbicide ranges from about 1:100 to about 100:1.

In an embodiment, the weight ratio of L-glufosinate, salts, esters, or combinations thereof and at least one protoporphyrinogen oxidase inhibitor herbicides is in a range from about 1:100 to about 100:1.

In an embodiment, the weight ratio of L-glufosinate, salts, esters, or combinations thereof and at least one acetyl CoA carboxylase inhibitor herbicides is in a range from about 1:100 to about 100:1.

In an embodiment, the weight ratio of L-glufosinate, salts, esters, or combinations thereof and at least one auxin mimics herbicides is in a range from about 1:100 to about 100:1.

In an embodiment, the weight ratio of L-glufosinate, salts, esters, or combinations thereof and at least one acetolactate synthase inhibitor herbicides is in a range from about 1:100 to about 100:1.

In an embodiment, the weight ratio of L-glufosinate, salts, esters, or combinations thereof and at least one hydroxyphenyl pyruvate dioxygenase inhibitor herbicides is in a range from about 1:100 to about 100:1.

In a preferred embodiment, the weight ratio of L-glufosinate, salts, esters, or combinations thereof and at least one additional herbicide is selected from ratios comprising 1:1, 1:10, 1:20, 1:30, 1:40, 1:50, 1:60, 1:70, 1:80, 1:90 and 1:100.

In a preferred embodiment, the weight ratio of L-glufosinate, salts, esters, or combinations thereof and at least one additional herbicide is selected from ratios comprising 1:1, 10:1, 20:1, 30:1, 40:1, 50:1, 60:1, 70:1, 80:1, 90:1 and 100:1.

In another embodiment, the weight ratio of L-glufosinate, salts, esters, or combinations thereof and at least one additional herbicide ranges from about 1:75 to about 75:1.

In still another embodiment, the weight ratio of L-glufosinate, salts, esters, or combinations thereof and at least one additional herbicide is in a range from about 1:50 to about 50:1.

In still another embodiment, the weight ratio of L-glufosinate, salts, esters, or combinations thereof to at least one additional herbicide is in a range from about 1:25 to about 25:1.

In still another embodiment, the weight ratio L-glufosinate, salts, esters, or combinations thereof and at least one additional herbicide is in a range from about 1:10 to about 10:1.

In a preferred embodiment, the weight ratio L-glufosinate, salts, esters, or combinations thereof and at least one additional herbicide is in a range from about 1:6 to about 6:1.

In a preferred embodiment, the weight ratio of L-glufosinate, salts, esters, or combinations thereof and at least one additional herbicide is in a range from about 1:5 to about 5:1.

In a preferred embodiment, the weight ratio of L-glufosinate, salts, esters, or combinations thereof and at least one protoporphyrinogen oxidase inhibitor herbicide is about 1:2.5.

In a preferred embodiment, the weight ratio of L-glufosinate ammonium and saflufenacil is about 1:2.5.

In a preferred embodiment, the weight ratio of L-glufosinate, salts, esters, or combinations thereof and at least one auxin mimics herbicide is about 1:1.6.

In a preferred embodiment, the weight ratio of L-glufosinate ammonium and triclopyr is about 1:1.6.

In a preferred embodiment, the weight ratio of L-glufosinate, salts, esters, or combinations thereof and at least one auxin mimics herbicide is about 1:1.7.

In a preferred embodiment, the weight ratio of L-glufosinate ammonium and 2,4-D choline is about 1:1.7.

In a preferred embodiment, the weight ratio of L-glufosinate, salts, esters, or combinations thereof and at least one acetyl CoA carboxylase inhibitor herbicide is about 5.6:1.

In a preferred embodiment, the weight ratio of L-glufosinate ammonium and quizalofop-ethyl is about 5.6:1.

In a preferred embodiment, the weight ratio of L-glufosinate, salts, esters, or combinations thereof and at least one acetyl CoA carboxylase inhibitor herbicide is about 2.33:1.

In a preferred embodiment, the weight ratio of L-glufosinate ammonium and quizalofop-p-tefuryl is about 2.33:1.

In a preferred embodiment, the weight ratio of L-glufosinate, salts, esters, or combinations thereof and at least one hydroxyphenyl pyruvate dioxygenase inhibitor herbicide is about 1:1.7.

In a preferred embodiment, the weight ratio of L-glufosinate ammonium and mesotrione is about 1:1.7.

In a preferred embodiment, the weight ratio of L-glufosinate, salts, esters, or combinations thereof and at least one acetolactate synthase inhibitor herbicide is about 1:1.8.

In a preferred embodiment, the weight ratio of L-glufosinate ammonium and Imazapic is 1:1.8.

In a preferred embodiment, the weight ratio of L-glufosinate, salts, esters, or combinations thereof and at least one acetolactate synthase inhibitor herbicide is about 1.6:1.

In a preferred embodiment, the weight ratio of L-glufosinate ammonium and Imazapyr is 1.6:1.

In an embodiment, the at least one additional herbicide which can be combined L-glufosinate, salts, esters, or combinations thereof is selected from the group comprising:
(a) protoporphyrinogen oxidase inhibitor herbicide;
(b) acetyl CoA carboxylase inhibitor herbicide;
(c) auxin mimics herbicide;
(d) acetolactate synthase inhibitor herbicides;
(e) hydroxyphenyl pyruvate dioxygenase inhibitor herbicides;
or combinations thereof.

In an embodiment, the weight ratio of L-glufosinate, salts, esters, or combinations thereof, at least one protoporphyrinogen oxidase inhibitor herbicides and at least one auxin mimics herbicide is in a range from about 1:100:100 to about 100:1:1.

In a preferred embodiment, the weight ratio of L-glufosinate, salts, esters, or combinations thereof, at least one protoporphyrinogen oxidase inhibitor herbicides and at least one auxin mimics herbicide is selected from ratios comprising 1:100:100, 10:90:90, 20:80:80, 30:70:70, 40:60:60, 50:50:50, 60:40:40, 70:30:30, 80:20:20, 90:10:10, and 100:1:1.

In an embodiment, the weight ratio of L-glufosinate ammonium, at least one protoporphyrinogen oxidase inhibitor herbicides and at least one auxin mimics herbicide is about 1:2.5:1.62.

In a preferred embodiment, the weight ratio of L-glufosinate ammonium, saflufenacil and triclopyr is about 1:2.5:1.62.

In an embodiment, the weight ratio of L-glufosinate ammonium, at least one protoporphyrinogen oxidase inhibitor herbicides and at least one auxin mimics herbicide is about 1:2.5:1.7.

In a preferred embodiment, the weight ratio of L-glufosinate ammonium, saflufenacil and 2,4-D choline is about 1:2.5:1.7.

In an embodiment, the weight ratio of L-glufosinate, salts, esters, or combinations thereof and at least two acetolactate synthase inhibitor herbicide is about 1:1.8:0.6.

In a preferred embodiment, the weight ratio of L-glufosinate ammonium, Imazapic and Imazapyr is about 1:1.8:0.6.

In another aspect, the present disclosure provides a method of controlling Amaranthus genus weeds at a locus, the method comprising applying a synergistic herbicidal combination comprising L-glufosinate, salts, esters, or combinations thereof and at least one additional herbicide selected from the group comprising:
(a) protoporphyrinogen oxidase inhibitor herbicides;
(b) acetyl CoA carboxylase inhibitor herbicides;
(c) auxin mimics herbicide;
(d) acetolactate synthase inhibitor herbicides;
(e) hydroxyphenyl pyruvate dioxygenase inhibitor herbicides;
or combinations thereof.

In an embodiment, the method comprises application of present herbicidal combinations to a locus of a plant, wherein Amaranthus genus weeds occurs or are expected to occur.

In an embodiment, the method of controlling Amaranthus genus weeds comprises applying at a locus thereof, a synergistic herbicidal combination comprising L-glufosinate, salts, esters, or combinations thereof and at least one additional herbicide, wherein L-glufosinate, salts, esters, or combinations thereof is applied at an application rate from about 50 g a.i./ha to about 350 g a.i./ha.

In an embodiment, the method of controlling Amaranthus genus weeds comprises applying at a locus thereof, a synergistic herbicidal combination comprising L-glufosinate, salts, esters, or combinations thereof and at least one additional herbicide, wherein L-glufosinate, salts, esters, or combinations thereof is applied at an application rate from about 100 g a.i./ha to about 250 g a.i./ha.

In a preferred embodiment, L-glufosinate ammonium used in the present combination is applied at an application rate of about 150 g a.i./ha.

In another embodiment, the present disclosure provides a method of controlling Amaranthus genus weeds comprising applying at a locus thereof, a synergistic herbicidal combination comprising at least one additional herbicide selected from the group comprising:
(a) the protoporphyrinogen oxidase inhibitor herbicide is applied at an application rate from about 5 g a.i./ha to about 200 g a.i./ha;
(b) the acetyl CoA carboxylase inhibitor herbicide is applied at an application rate from about 5 g a.i./ha to about 200 g a.i./ha;
(c) the auxin mimics herbicide is applied at an application rate from about 50 g a.i./ha to about 600 g a.i./ha;
(d) the acetolactate synthase inhibitor herbicide is applied at an application rate from about 5 g a.i./ha to about 100 g a.i./ha; and
(e) the hydroxyphenyl pyruvate dioxygenase inhibitor herbicide is applied at an application rate from about 10 g a.i./ha to about 400 g a.i./ha.

In another embodiment, the present disclosure provides a method of controlling Amaranthus genus weeds comprising applying at a locus thereof, a synergistic herbicidal combination comprising L-glufosinate, salts, esters, or combinations thereof and at least one additional herbicide selected from protoporphyrinogen oxidase inhibitor herbicide, wherein the protoporphyrinogen oxidase inhibitor herbicide is applied at an application rate from about 5 g a.i./ha to about 200 g a.i./ha.

In an embodiment, the protoporphyrinogen oxidase inhibitor herbicide used in the present combination is applied at an application rate from about 10 g a.i./ha to about 100 g a.i./ha.

In an embodiment, the protoporphyrinogen oxidase inhibitor herbicide used in the present combination is applied at an application rate from about 15 g a.i./ha to about 45 g a.i./ha.

In a preferred embodiment, saflufenacil used in the present combination is applied at an application rate of about 30 g a.i./ha.

In another embodiment, the present disclosure provides a method of controlling Amaranthus genus weeds comprising applying at a locus thereof, a synergistic herbicidal combination comprising L-glufosinate, salts, esters, or combinations thereof and at least one additional herbicide selected from acetyl CoA carboxylase inhibitor herbicide, wherein the acetyl CoA carboxylase inhibitor herbicide is applied at an application rate from about 5 g a.i./ha to about 200 g a.i./ha.

In an embodiment, the amount of acetyl CoA carboxylase inhibitor herbicide used in the present combination is applied at an application rate from about 5 g a.i./ha to about 100 g a.i./ha.

In an embodiment, the amount of acetyl CoA carboxylase inhibitor herbicide used in the present combination is applied at an application rate from about 5 g a.i./ha to about 50 g a.i./ha.

In a preferred embodiment, quizalofop-ethyl used in the present combination is applied at an application rate of about 25 g a.i./ha.

In a preferred embodiment, quizalofop-p-tefuryl used in the present combination is applied at an application rate of about 25 g a.i./ha.

In another embodiment, the present disclosure provides a method of controlling Amaranthus genus weeds comprising applying at a locus thereof, a synergistic herbicidal combination comprising L-glufosinate or salts thereof and an additional herbicide selected from at least one auxin mimics herbicide, wherein the auxin mimics herbicide is applied at an application rate from about 50 g a.i./ha to about 600 g a.i./ha.

In an embodiment, the amount of auxin mimics herbicide used in the present combination is applied at an application rate from about 100 g a.i./ha to about 400 g a.i./ha.

In an embodiment, the amount of auxin mimics herbicide used in the present combination is applied at an application rate from about 150 g a.i./ha to about 350 g a.i./ha.

In a preferred embodiment, triclopyr used in the present combination is applied at an application rate of about 228 g a.i./ha.

In a preferred embodiment, 2,4-D choline used in the present combination is applied at an application rate of about 228 g a.i./ha.

In another embodiment, the present disclosure provides a method of controlling Amaranthus genus weeds comprising applying at a locus thereof, a synergistic herbicidal combination comprising L-glufosinate or salts thereof and an additional herbicide selected from at least one acetolactate synthase inhibitor herbicide, wherein the acetolactate synthase inhibitor herbicide is applied at an application rate from about 5 g a.i./ha to about 100 g a.i./ha.

In an embodiment, the amount of acetolactate synthase inhibitor herbicide used in the present combination is applied at an application rate from about 5 g a.i./ha to about 80 g a.i./ha.

In an embodiment, the amount of acetolactate synthase inhibitor herbicide used in the present combination is applied at an application rate from about 5 g a.i./ha to about 60 g a.i./ha.

In an embodiment, the amount of acetolactate synthase inhibitor herbicide used in the present combination is applied at an application rate from about 5 g a.i./ha to about 20 g a.i./ha.

In an embodiment, the amount of acetolactate synthase inhibitor herbicide used in the present combination is applied at an application rate of about 10.5 g a.i./ha, wherein the acetolactate synthase inhibitor herbicide is Imazapyr.

In an embodiment, the amount of acetolactate synthase inhibitor herbicide used in the present combination is applied at an application rate from about 20 to about 40 g a.i./ha.

In an embodiment, the amount of acetolactate synthase inhibitor herbicide used in the present combination is applied at an application rate of about 31.5 g a.i./ha, wherein the acetolactate synthase inhibitor herbicide is Imazapic.

In another embodiment, the present disclosure provides a method of controlling Amaranthus genus weeds comprising applying at a locus thereof, a synergistic herbicidal combination comprising L-glufosinate or salts thereof and an additional herbicide selected from at least one hydroxyphenyl pyruvate dioxygenase inhibitor herbicide, wherein the hydroxyphenyl pyruvate dioxygenase inhibitor herbicide is applied at an application rate from about 10 to about 400 g a.i./ha.

In an embodiment, the amount of hydroxyphenyl pyruvate dioxygenase inhibitor herbicide used in the present combination is applied at an application rate from about 25 to about 250 g a.i./ha.

In an embodiment, the amount of hydroxyphenyl pyruvate dioxygenase inhibitor herbicide used in the present combination is applied at an application rate from about 50 to about 150 g a.i./ha.

In a preferred embodiment, mesotrione used in the present combination is applied at an application rate of about 100 g a.i./ha.

In another aspect, there is provided use of a synergistic herbicidal combination for controlling Amaranthus genus weeds.

In another aspect, there is provided use of a synergistic herbicidal combination comprising L-glufosinate, salts, esters, or combinations thereof and at least one additional herbicide, for controlling Amaranthus genus weeds.

In another aspect, there is provided use of a synergistic herbicidal combination comprising L-glufosinate ammonium and at least one additional herbicide, for controlling Amaranthus genus weeds.

In another aspect, there is provided use of a synergistic herbicidal combination for controlling Amaranthus genus weeds, wherein said synergistic herbicidal combination comprises:
(a) L-glufosinate, salts, esters, or combinations thereof; and
(b) at least one additional herbicide selected from the group comprising protoporphyrinogen oxidase inhibitor herbicide, acetyl CoA carboxylase inhibitor herbicide, auxin mimics herbicide, acetolactate synthase inhibitor herbicides, hydroxyphenyl pyruvate dioxygenase inhibitor herbicides, or combinations thereof.

In another aspect, there is provided use of a synergistic herbicidal combination for controlling Amaranthus genus weeds, wherein said synergistic herbicidal combination comprises:
(a) L-glufosinate ammonium; and
(b) at least one additional herbicide selected from the group comprising protoporphyrinogen oxidase inhibitor herbicide, acetyl CoA carboxylase inhibitor herbicide, auxin mimics herbicide, acetolactate synthase inhibitor herbicide, hydroxyphenyl pyruvate dioxygenase inhibitor herbicide, or combinations thereof.

In an embodiment, the herbicidal combinations of the present disclosure can be used in agricultural lands such as fields, paddy fields, lawns, orchards; or in non-agricultural lands. The present disclosure may be used to control diseases in agricultural lands for cultivating the plants without causing any phytotoxicity to the plant.

In an embodiment, the compositions and methods disclosed herein can be used to control undesired vegetation in a variety of crop and non-crop applications. In some embodiments, the compositions and methods disclosed herein can be used for controlling undesired vegetation in crops.

Examples of the crops on which the combinations according to the present disclosure may be used include, but are not limited to, corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., Asteraceae vegetables such as burdock, crown daisy, artichoke, lettuce, etc, liliaceous vegetables such as green onion, onion, garlic, and asparagus, ammiaceous vegetables such as carrot, parsley, celery, parsnip, etc., Chenopodiaceous vegetables such as spinach, Swiss chard, etc., Lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, eucalyptus, Ginkgo biloba, lilac, maple, Quercus, poplar, Judas tree, Liquidambar formosana, plane tree, Zelkova, Japanese arborvitae, fir wood, hemlock, juniper, Pinus, Picea, and Taxus cuspidate, or combinations thereof.

In another embodiment, the present disclosure provides a herbicidal composition for controlling Amaranthus genus weeds, said composition comprising:
(a) L-glufosinate, salts, esters, or combinations thereof; and
(b) at least one additional herbicide selected from the group comprising protoporphyrinogen oxidase inhibitor herbicide, acetyl CoA carboxylase inhibitor herbicide, auxin mimics herbicide, acetolactate synthase inhibitor herbicides, hydroxyphenyl pyruvate dioxygenase inhibitor herbicides, or combinations thereof.

In another embodiment, the present disclosure provides a herbicide composition for controlling Amaranthus genus weeds, said composition comprising
(a) L-glufosinate ammonium; and
(b) at least one additional herbicide selected from the group comprising protoporphyrinogen oxidase inhibitor herbicide, acetyl CoA carboxylase inhibitor herbicide, auxin mimics herbicide, acetolactate synthase inhibitor herbicides, hydroxyphenyl pyruvate dioxygenase inhibitor herbicides, or combinations thereof.

In an embodiment, the amount L-glufosinate, salts, esters, or combinations thereof present in the herbicide composition is in the range of about 100 g a.i./L to 400 g a.i./L.

In an embodiment, the amount of L-glufosinate, salts, esters, or combinations thereof present in the herbicide composition is in the range of about 180 g a.i./L to 380 g a.i./L.

In an embodiment, the amount of L-glufosinate, salts, esters, or combinations thereof present in the herbicide composition is in the range of about 250 g a.i./L to 350 g a.i./L.

In a preferred embodiment, the amount of L-glufosinate ammonium present in the herbicide composition is about 280 g a.i./L.

In an embodiment, the present disclosure provides a herbicidal combination comprising at least one additional herbicide selected from the group comprising:
(a) the protoporphyrinogen oxidase inhibitor herbicide is in a range from about 300 g a.i./L to about 1200 g a.i./L;
(b) the acetyl CoA carboxylase inhibitor herbicide is in a range from about 5 g a.i./L to about 200 g a.i./L;
(c) the auxin mimics herbicide is in a range from about 100 g a.i./L to about 1000 g a.i./L;
(d) the acetolactate synthase inhibitor herbicide is in a range from about 100 g a.i./L to about 1100 g a.i./L; and
(e) the hydroxyphenyl pyruvate dioxygenase inhibitor herbicide is in a range from about 250 g a.i./L to about 750 g a.i./L.

In another embodiment, the present disclosure provides a method of controlling Amaranthus genus weeds comprising applying at a locus a synergistic combination comprising L-glufosinate, salts, esters, or combinations thereof and at least one additional herbicide selected from the protoporphyrinogen oxidase inhibitor herbicide, wherein the protoporphyrinogen oxidase inhibitor herbicide is present in an amount in the range from about 300 g a.i./L to about 1200 g a.i./L.

In an embodiment, the amount of protoporphyrinogen oxidase inhibitor herbicide used in the present combination is in the range from about 400 g a.i./L to about 1000 g a.i./L.

In an embodiment, the amount of protoporphyrinogen oxidase inhibitor herbicide used in the present combination is in the range from about 600 g a.i./L to about 800 g a.i./L.

In a preferred embodiment, the amount of saflufenacil used in the present combination is about 700 g a.i./L.

In another embodiment, the present disclosure provides a method of controlling Amaranthus genus weeds comprising applying at a locus a synergistic combination comprising L-glufosinate, salts, esters, or combinations thereof and at least one additional herbicide selected from the acetyl CoA carboxylase herbicide, wherein the acetyl CoA carboxylase herbicide is present in an amount in the range from about 10 g a.i./L to about 800 g a.i./L.

In an embodiment, the amount of acetyl CoA carboxylase inhibitor herbicide used in the present combinations is in the range from about 10 g a.i./L to about 500 g a.i./L.

In an embodiment, the amount of acetyl CoA carboxylase inhibitor herbicide used in the present combinations is in the range from about 20 g a.i./L to about 200 g a.i./L.

In an embodiment, the amount of acetyl CoA carboxylase inhibitor herbicide used in the present combinations is in the range from about 75 g a.i./L to about 150 g a.i./L, wherein the acetyl CoA carboxylase inhibitor herbicide is Quizalofop-p-tefuryl.

In an embodiment, the amount of acetyl CoA carboxylase inhibitor herbicide used in the present combinations from about 120 g a.i./L, wherein the acetyl CoA carboxylase inhibitor herbicide is Quizalofop-p-tefuryl.

In an embodiment, the amount of acetyl CoA carboxylase inhibitor herbicide used in the present combinations is in the range from about 25 g a.i./L to about 75 g a.i./L, wherein the acetyl CoA carboxylase inhibitor herbicide is Quizalofop-ethyl.

In an embodiment, the amount of acetyl CoA carboxylase inhibitor herbicide used in the present combinations from about 50 g a.i./L, wherein the acetyl CoA carboxylase inhibitor herbicide is Quizalofop-ethyl.

In another embodiment, the present disclosure provides a method of controlling Amaranthus hybridus comprising applying a synergistic combination comprising L-glufosinate, salts, esters, or combinations thereof and at least one additional herbicide selected from auxin herbicide, wherein the auxin herbicide is present in an amount in the range from about 100 g a.i./L to about 1000 g a.i./L.

In an embodiment, the amount of auxin herbicide used in the present combinations is in the range from about 200 g a.i./L to about 700 g a.i./L.

In an embodiment, the amount of auxin herbicide used in the present combinations is in the range from about 300 g a.i./L to about 600 g a.i./L.

In a preferred embodiment, the amount of triclopyr used in the present combinations is about 456 g a.i./L.

In a preferred embodiment, the amount of 2,4-D Choline used in the present combinations is about 480 g a.i./L.

In another embodiment, the present disclosure provides a method of controlling Amaranthus hybridus comprising applying a synergistic combination comprising L-glufosinate, salts, esters, or combinations thereof and at least one additional herbicide selected from hydroxyphenyl pyruvate dioxygenase inhibitor herbicides, wherein the hydroxyphenyl pyruvate dioxygenase inhibitor herbicide is present in an amount in the range from about 200 g a.i./L to about 750 g a.i./L.

In an embodiment, the amount of hydroxyphenyl pyruvate dioxygenase inhibitor herbicide used in the present combinations is in the range from about 300 g a.i./L to about 650 g a.i./L.

In an embodiment, the amount of hydroxyphenyl pyruvate dioxygenase inhibitor herbicide used in the present combinations is in the range from about 400 g a.i./L to about 550 g a.i./L.

In a preferred embodiment, the amount of mesotrione used in the present combinations is about 480 g a.i./L.

In another embodiment, the present disclosure provides a method of controlling Amaranthus hybridus comprising applying a synergistic combination comprising L-glufosinate, salts, esters, or combinations thereof and at least one additional herbicide selected from acetolactate synthase inhibitor herbicide, wherein the acetolactate synthase inhibitor herbicide is present in an amount in the range from about 100 g a.i./L to about 1100 g a.i./L.

In another embodiment, the present disclosure provides a method of controlling Amaranthus hybridus comprising applying a synergistic combination comprising L-glufosinate, salts, esters, or combinations thereof and at least one additional herbicide selected from acetolactate synthase inhibitor herbicide, wherein the acetolactate synthase inhibitor herbicide is present in an amount in the range from about 300 g a.i./L to about 1100 g a.i./L.

In an embodiment, the amount of acetolactate synthase inhibitor herbicide used in the present combinations is in the range from about 500 g a.i./L to about 900 g a.i./L.

In an embodiment, the amount of acetolactate synthase inhibitor herbicide used in the present combinations is in the range from about 600 g a.i./L to about 800 g a.i./L.

In a preferred embodiment, the amount of imazapic used in the present combinations is about 525 g a.i./L.

In a preferred embodiment, the amount of imazapyr used in the present combinations is about 175 g a.i./L.

In an embodiment, the present invention provides L-glufosinate, salts, esters, or combinations thereof in combination with at least one additional herbicide, wherein the combination provides from about 50% to about 100% control of the weeds.

In an embodiment, the present invention provides the use of L-glufosinate, salts, esters, or combinations thereof applied at a rate of 150 g a.i./ha, in combination with at least one additional herbicide applied in a range from about 5 g a.i./ha to about 300 g a.i./ha, wherein the combination provides from about 50% to about 100% control of the weeds.

In an embodiment, the present invention provides the use of L-glufosinate, salts, esters, or combinations thereof applied at a rate of 150 g a.i./ha, in combination with saflufenacil applied at a rate of 30 g a.i./ha for controlling Amaranthus hybridus, wherein the combination provides about 90% control of the weed at or within 3 days after application (DAA).

In an embodiment, the present invention provides the use of L-glufosinate, salts, esters, or combinations thereof applied at a rate of 150 g a.i./ha, in combination with saflufenacil applied at a rate of 30 g a.i./ha and triclopyr applied at a rate of 228 g a.i./ha, for controlling Amaranthus hybridus, wherein the combination provides about 100% control of the weed at or within 3 days after application (DAA).

In an embodiment, the present invention provides the use of L-glufosinate, salts, esters, or combinations thereof applied at a rate of 150 g a.i./ha, in combination with saflufenacil applied at a rate of 30 g a.i./ha and 2,4-D choline applied at a rate of 228 g a.i./ha, for controlling Amaranthus hybridus, wherein the combination provides about 100% control of the weed at or within 3 days after application (DAA).

In an embodiment, the present invention provides the use of L-glufosinate, salts, esters, or combinations thereof applied at a rate of 150 g a.i./ha, in combination with quizalofop-ethyl applied at a rate of 25 g a.i./ha for controlling Amaranthus hybridus, wherein the combination provides about 51% control of the weed at or within 3 days after application (DAA).

In an embodiment, the present invention provides the use of L-glufosinate, salts, esters, or combinations thereof applied at a rate of 150 g a.i./ha, in combination with quizalofop-p-tefuryl applied at a rate of 25 g a.i./ha for controlling Amaranthus hybridus, wherein the combination provides about 65% control of the weed at or within 14 days after application (DAA).

In an embodiment, the present invention provides the use of L-glufosinate, salts, esters, or combinations thereof applied at a rate of 150 g a.i./ha, in combination with mesotrione applied at a rate of 100 g a.i./ha, for controlling Amaranthus viridis, wherein the combination provides about 70% control of the weed at or within 3 days after application (DAA) and about 95% control of the weed at or within 7 days after application (DAA).

In an embodiment, the present invention provides the use of L-glufosinate, salts, esters, or combinations thereof applied at a rate of 150 g a.i./ha, in combination with imazapic applied at a rate of 31.5 g a.i./ha and imazapyr applied at a rate of 10.5 g a.i./ha, for controlling Amaranthus viridis, wherein the combination provides about 70% control of the weed at or within 3 days after application (DAA).

In an embodiment, the herbicidal compositions according to the present disclosure for controlling Amaranthus genus weeds, comprises at least one agrochemically acceptable excipient/additive in addition to L-glufosinate, salts, esters, or combinations thereof and at least one additional herbicide.

In another embodiment, the present disclosure provides a herbicidal composition for controlling Amaranthus genus weeds, said composition comprising:
(a) L-glufosinate, salts, esters, or combinations thereof; and
(b) at least one additional herbicide selected from the group comprising protoporphyrinogen oxidase inhibitor herbicide, acetyl CoA carboxylase inhibitor herbicide, auxin mimics herbicide, acetolactate synthase inhibitor herbicides, hydroxyphenyl pyruvate dioxygenase inhibitor herbicides, or combinations thereof; and
(c) at least agrochemically acceptable excipient.

In another embodiment, the present disclosure provides a herbicidal composition for controlling Amaranthus genus weeds, said composition comprising:
(a) L-glufosinate ammonium; and
(b) at least one additional herbicide selected from the group comprising protoporphyrinogen oxidase inhibitor herbicide, acetyl CoA carboxylase inhibitor herbicide, auxin mimics herbicide, acetolactate synthase inhibitor herbicides, hydroxyphenyl pyruvate dioxygenase inhibitor herbicides, or combinations thereof; and
(c) at least agrochemically acceptable excipient.

In a preferred embodiment, the Amaranthus genus weed is Amaranthus hybridus.

In a preferred embodiment, the Amaranthus genus weed is Amaranthus viridis.

In an embodiment, the present combinations/compositions can further comprise one or more insecticides, fungicides, co-herbicides, or combinations thereof.

In an embodiment, the examples of co-herbicides that can be combined with present herbicidal combinations comprise tetflupyrolimet, dioxopyritrione, rimisoxafen, benquitrione, bipyrazone, cypyrafluone, fenpyrazone, tripyrasulfone, anisiflupurin, beflubutamid, bixlozone, SL-1201, cyclopyranil, dimesulfazet, epyrifenacil, topramezone, orthosulfamuron, pinoxaden, metamifop, pyrimisulfan, tembotrione, thiencarbazone methyl, flucetosulfuron, aminopyralid, pyrasulfotole, saflufenacil, pyroxsulam, pyroxasulfone, pyraclonil, indaziflam, fenquinotrione, florpyrauxifen-benzyl, tiafenacil, cinmethylin, lancotrione-sodium, bixlozone, trifludimoxazin, cyclopyrimorate, methiozolin, aminocyclopyrachlor, metazosulfuron, ipfencarbazone, fenoxasulfone, bicyclopyrone, triafamone, halauxifen methyl, tolpyralate, or combinations thereof.

In an embodiment, the agrochemically acceptable excipients/carriers/additives comprise at least one solvent(s), surfactant(s), colorant(s), dispersant(s), emulsifier(s), thickener(s), antifreeze agent(s), biocide(s), anti-foam agent(s), stabilizer(s), wetting agent(s), or combinations thereof.

In an embodiment, the surfactant(s) may be selected from non-ionic, anionic, cationic surfactants, or combinations thereof.

In an embodiment, the examples of non-ionic surfactants comprise polyarylphenol polyethoxy ethers, polyalkylphenol polyethoxy ethers, polyglycol ether derivatives of saturated fatty acids, polyglycol ether derivatives of unsaturated fatty acids, polyglycol ether derivatives of aliphatic alcohols, polyglycol ether derivatives of cycloaliphatic alcohols, fatty acid esters of polyoxyethylene sorbitan, alkoxylated vegetable oils, alkoxylated acetylenic diols, polyalkoxylated alkylphenols, fatty acid alkoxylates, sorbitan alkoxylates, sorbitol esters, C₈-C₂₂ alkyl or alkenyl polyglycosides, polyalkoxy styrylaryl ethers, alkylamine oxides, block copolymer ethers, polyalkoxylated fatty glyceride, polyalkylene glycol ethers, linear aliphatic or aromatic polyesters, organo silicones, polyaryl phenols, sorbitol ester alkoxylates, polyalkylene oxide block copolymers, acrylic copolymers and mono- and diesters of ethylene glycol, or combinations thereof.

In an embodiment, the examples of anionic surfactants comprise alcohol sulfates, alcohol ether sulfates, alkylaryl ether sulfates, alkylaryl sulfonates such as alkylbenzene sulfonates and alkylnaphthalene sulfonates and salts thereof, alkyl sulfonates, mono- or di-phosphate esters of polyalkoxylated alkyl alcohols or alkylphenols, mono- or di-sulfosuccinate esters of C₁₂-C₁₅ alkanols or polyalkoxylated C₁₂-C₁₅ alkanols, alcohol ether carboxylates, phenolic ether carboxylates, polybasic acid esters of ethoxylated polyoxyalkylene glycols consisting of oxybutylene or the residue of tetrahydrofuran, sulfoalkylamides and salts thereof, such as N-methyl-N-oleoyltaurate Na salt, polyoxyalkylene alkylphenol carboxylates, polyoxyalkylene alcohol carboxylates alkyl polyglycoside/alkenyl succinic anhydride condensation products, alkyl ester sulfates, napthalene sulfonates, naphthalene formaldehyde condensates, alkyl sulfonamides, sulfonated aliphatic polyesters, sulfate esters of styrylphenyl alkoxylates, and sulfonate esters of styrylphenyl alkoxylates and their corresponding sodium, potassium, calcium, magnesium, zinc, ammonium, alkylammonium, diethanolammonium, or triethanolammonium salts, salts of ligninsulfonic acid such as the sodium, potassium, magnesium, calcium or ammonium salt, polyarylphenol polyalkoxyether sulfates and polyarylphenol polyalkoxyether phosphates, and sulfated alkyl phenol ethoxylates, phosphated alkyl phenol ethoxylates, or combinations thereof.

In an embodiment, the cationic surfactants comprise alkanol amides of C₈-C₁₈ fatty acids and C₈-C₁₈ fatty amine polyalkoxylates, C₁₀-C₁₈ alkyldimethylbenzylammonium chlorides, coconut alkyldimethylaminoacetic acids, phosphate esters of C₈-C₁₈ fatty amine polyalkoxylates, or combinations thereof.

In an embodiment, the emulsifier(s) which can be advantageously employed herein can be readily determined by those skilled in the art and comprise various non-ionic, anionic, cationic and amphoteric emulsifiers, or a blend of two or more emulsifiers. Examples of non-ionic emulsifiers useful in preparing emulsifiable concentrates, for example, comprise the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers comprise quaternary ammonium compounds and fatty amine salts. Anionic emulsifiers comprise the oil-soluble salts (e.g., calcium) of alkylaryl sulfonic acids, oil-soluble salts or sulfated polyglycol ethers and appropriate salts of phosphated polyglycol ether, or combinations thereof.

In an embodiment, the colorant(s) comprise iron oxide, titanium oxide and Prussian Blue, and organic dyestuffs, such as alizarin dyestuffs, azo dyestuffs or metal phthalocyanine dyestuffs, and trace elements, such as salts of iron, manganese, boron, copper, cobalt, molybdenum, zinc, or combinations thereof.

Another embodiment involves addition of a thickener or binder which may be selected from the group comprising molasses, granulated sugar, alginates, karaya gum, jaguar gum, tragacanth gum, polysaccharide gum, mucilage, xanthan gum, or combinations thereof. In another embodiment, the binder may be selected from the group comprising silicates such as magnesium aluminium silicate, polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof; polymers and copolymers of vinyl acetate, methyl cellulose, vinylidene chloride, acrylic, cellulose, polyvinylpyrrolidone and polysaccharide; polymers and copolymers of vinylidene chloride and vinyl acetate-ethylene copolymers; combinations of polyvinyl alcohol and sucrose; plasticizers such as glycerol, propylene glycol, polyglycols, or combinations thereof.

In another embodiment, an antifreeze agent(s) added to the composition may be alcohols selected from the group comprising ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol, or combinations thereof.

According to an embodiment, the biocide(s) comprise benzothiazoles, 1,2-benzisothiazolin-3-one, sodium dichloro-s-triazinetrione, sodium benzoate, potassium sorbate, 1,2-phenyl-isothiazolin-3-one, inter chloroxylenol paraoxybenzoate butyl, or combinations thereof.

According to an embodiment, the antifoam agent(s) comprise polydimethoxysiloxane, polydimethylsiloxane, alkyl poly acrylates, castor oil, fatty acids, fatty acid esters, fatty acid sulfates, fatty alcohols, fatty alcohol esters, fatty alcohol sulfates, olive oil, mono and di glycerides, paraffin oil, paraffin wax, polypropylene glycol, silicone oil, vegetable and animal fats, sulfates of vegetable and animal fat, vegetable and animal oils, sulfates of vegetable and animal oils, vegetable and animal waxes, sulfates of vegetable and animal waxes, agents based on silicon or magnesium stearate, or combinations thereof.

According to an embodiment, representative organic liquids which can be employed in preparing an emulsifiable concentrates include, for example, the aromatic liquids such as xylene, propyl benzene fractions, or mixed naphthalene fractions, mineral oils, substituted aromatic organic liquids such as dioctyl phthalate, kerosene, dialkyl amides of various fatty acids, particularly the dimethyl amides of fatty glycols and glycol derivatives such as the n-butyl ether, ethyl ether or methyl ether of diethylene glycol, and the methyl ether of triethylene glycol. Mixtures of two or more organic liquids are also often suitably employed in the preparation of an emulsifiable concentrate. The formulations can also contain other compatible additives, for example, plant growth regulators and other biologically active compounds used in agriculture.

According to an embodiment, the additives to be used for the formulation comprise, for example, a solid carrier such as kaolinite, sericite, diatomaceous earth, slaked lime, calcium carbonate, talc, white carbon, kaolin, bentonite, clay, sodium carbonate, sodium bicarbonate, mirabilite, zeolite or starch; a solvent such as water, toluene, xylene, solvent naphtha, dioxane, dimethylsulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenylether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or a salt of alkylnaphthalene sulfonic acid condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil, corn oil, rice bran oil, peanut oil, cottonseed oil, soybean oil, rapeseed oil, linseed oil, tung oil or liquid paraffins. These additives may suitably be selected for use alone or in combination as a mixture of two or more of them, so long as the object of the present disclosure is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be used.

According to an embodiment, the agrochemical formulation may also comprise one or more antioxidants. Preferably, the agrochemical formulation comprises an antioxidant. Antioxidants are, for example, amino acids (e.g., glycine, histidine, tyrosine, tryptophan) and derivatives thereof, imidazole and imidazole derivatives (e.g., urocanic acid), peptides, such as, for example, D,L-carnosine, D-carnosine, L-carnosine and derivatives thereof (e.g., anserine), carotenoids, carotenes (e.g., α-carotene, β-carotene, lycopene) and derivatives thereof, lipoic acid and derivatives thereof (e.g., dihydrolipoic acid), aurothioglucose, propylthiouracil and further thio compounds (e.g., thioglycerol, thiosorbitol, thioglycolic acid, thioredoxin, glutathione, cysteine, cystine, cystamine and the glycosyl, N-acetyl, methyl, ethyl, propyl, amyl, butyl, lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g., buthionine sulfoximines, homocysteine sulfoximine, buthionine sulfones, penta-, hexa-, heptathionine sulfoximine) in very low tolerated doses (e.g., pmol/kg to pmol/kg), also metal chelating agents (e.g., α-hydroxy fatty acids, EDTA (Ethylenediaminetetraacetic acid), EGTA (Ethylenebis(oxyethylenenitrilo)tetraacetic acid), phytic acid, lactoferrin), α-hydroxy acids (e.g., citric acid, lactic acid, malic acid), humic acids, bile acid, bile extracts, gallic esters (e.g., propyl, octyl and dodecyl gallate), flavonoids, catechins, bilirubin, biliverdin and derivatives thereof, unsaturated fatty acids and derivatives thereof (e.g., γ-linolenic acid, linoleic acid, arachidonic acid, oleic acid), folic acid and derivatives thereof, hydroquinone and derivatives thereof (e.g., arbutin), ubiquinone and ubiquinol, and derivatives thereof, vitamin C and derivatives thereof (e.g., ascorbyl palmitate, stearate, dipalmitate, acetate, Mg ascorbyl phosphates, sodium and magnesium ascorbate, disodium ascorbyl phosphate and sulfate, potassium ascorbyl tocopheryl phosphate, chitosan ascorbate), isoascorbic acid and derivatives thereof, tocopherols and derivatives thereof (e.g., tocopheryl acetate, linoleate, oleate and succinate, tocophereth-5, tocophereth-10, tocophereth-12, tocophereth-18, tocophereth-50, tocophersolan), vitamin A and derivatives (e.g., vitamin A palmitate), the coniferyl benzoate of benzoin resin, rutin, rutinic acid and derivatives thereof, disodium rutinyl disulfate, cinnamic acid and derivatives thereof (e.g., ferulic acid, ethyl ferulate, caffeic acid), kojic acid, chitosan glycolate and salicylate, butylhydroxytoluene, butylhydroxyanisol, nordihydroguaiacic acid, nordihydroguaiaretic acid, trihydroxybutyrophenone, uric acid and derivatives thereof, mannose and derivatives thereof, selenium and selenium derivatives (e.g., selenomethionine), stilbenes and stilbene derivatives (e.g., stilbene oxide, trans-stilbene oxide). According to an embodiment, the mixtures of the aforementioned antioxidants are possible.

According to an embodiment, the examples of solvents are water, aromatic solvents (for example xylene), paraffins (for example mineral oil fractions such as kerosene or diesel oil), coal tar oils and oils of vegetable or animal origin, aliphatic, cyclic and aromatic hydrocarbons, for example toluene, xylene, paraffin, tetrahydronaphthalene, alkylated naphthalenes or their derivatives, alcohols (for example methanol, butanol, pentanol, benzyl alcohol, cyclohexanol), ketones (for example cyclohexanone, gamma-butyrolactone), pyrrolidones, N-Methyl-2-pyrrolidone (NMP), N-Ethyl-2 pyrrolidone (NEP), N-Octyl-2-pyrrolidone (NOP), acetates (glycol diacetate), glycols, fatty acid dimethylamides, fatty acids and fatty acid esters, isophorone and dimethylsulfoxide, or combinations thereof.

According to an embodiment, solvent mixtures may also be used.

According to an embodiment, exemplary surfactants comprise alkali metal, alkaline earth metal and ammonium salts of lignosulfonic acid, naphthalenesulfonates, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenol ethers, ethoxylated isooctylphenol, octylphenol, nonylphenol, alkylphenol polyglycol ethers, tributylphenyl polyglycol ethers, tristearylphenyl polyglycol ethers, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose, or combinations thereof.

According to an embodiment, examples of carriers comprise mineral earths such as silica gels, silicates, talc, kaolin, attaclay, attapulgite, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, urea, and products of vegetable origin, such as cereal meal, tree bark meal, wood meal and nutshell meal, cellulose powders, polyvinylpyrrolidone and other solid carriers, or combinations thereof.

According to an embodiment, exemplary preservatives comprise 1,2-benzisothiazolin-3-one and/or 2-Methyl-2H-isothiazol-3-one or sodium benzoate or benzoic acid, or combinations thereof.

In another aspect, present compositions may further comprise at least one safener.

In an embodiment the safener can be selected from the group comprising isoxadifen-ethyl, cloquintocet-mexyl, mefenpyr-diethyl, naphthalic anhydride, oxabetrinil, benzenesulfonamide, N-(aminocarbonyl)-2-chlorobenzene sulfonamide (2-CBSU), daimuron, dichloroacetamide, dicyclonon, fenchlorazole-ethyl, fenclorim, fluxofenim, Dichloroacetamide safeners (e.g., AD-67, benoxacor, dichlormid, and furilazole), naphthopyranone, naphthalic anhydride (NA), oxime, phenylpyrimidine, phenylurea, phenyl pyrazoles compounds, naphthalic anhydride, cyometrinil, flurazole, dimepiperate, methoxyphenone, cloquintocet-mexyl (CGA-185072), 1-dichloroacetylhexahydro-3,3,8α-trimethylpyrrolo[1,2-α]pyrimidin-6-(2H-one) (BAS-145138), dichloromethyl-1,3-dioxolane (MG-191), quinolinyloxyacetate compounds, or agriculturally acceptable salts, esters, or combinations thereof.

In an embodiment, the composition may be present in any agrochemically suitable form for storage and application to the ground. The compositions may be produced by mixing the actives in the composition with an inert carrier and adding surfactants and other adjuvants and carriers as needed and formulated into solid or liquid formulations, comprising wettable powders (WP), granules (GR), dusts, soluble (liquid) concentrates (SL), suspension concentrates (SC), oil in water emulsion (EW), water in oil emulsion (EO), emulsifiable concentrates (EC), capsule suspensions (CS), mixed formulation of CS and SC (ZC) formulations, oil dispersions (OD), other known formulation types, or combinations thereof. The composition may also be used for treatment of a plant propagation material, such as seeds, etc.

The herbicidal compositions of the present disclosure can be present in any conventional agrochemically useful form, for example, in a form of a ready-to-use formulation (premix or ready-mix), or in a form of a tank mix.

In an embodiment, compositions/combination of the present disclosure may be applied either pre-emergence or post-emergence. Advantageously, the present combinations provide significant and improved control of weeds, when applied in post-emergence stage.

In an embodiment, the method for controlling target weeds comprises applying a premix formulation or a tank-mix formulation comprising L-glufosinate, salts, esters, or combinations thereof and at least one additional herbicide, at the desired locus.

In an embodiment, the method for controlling target weeds comprises applying a premix formulation or a tank-mix formulation comprising L-glufosinate, salts, esters, or combinations thereof and at least one additional herbicide, at the desired locus.

In an embodiment, the premix formulation or the tank-mix formulation comprising L-glufosinate, salts, esters, or combinations thereof and at least one additional herbicide further comprises at least one co-herbicide.

In an embodiment, each individual composition further comprises at least one agrochemically acceptable excipient/ingredients. The resulting premix formulation or tank-mix formulation of the composition comprising L-glufosinate, salts, esters, or combinations thereof, at least one additional herbicide, and at least one or co-herbicide provides a synergistic effect in controlling Amaranthus genus weeds.

In an embodiment, the herbicides of the combinations of the present disclosure may be applied simultaneously as a tank mix formulation or in a premix formulation or may be applied sequentially. The sequential application may be in immediate succession or with a time gap and may be carried in any order as deemed to be effective by the person skilled in the art. The application may be made to the soil before emergence of the plants, either pre-planting or post-planting. The application may be made to the soil after emergence of the plants. The application may be made as a foliar spray at different timings during crop development, with either one or more applications early or late post-emergence. Herbicidal compositions according to the disclosure can also be incorporated into the soil before, during or after sowing seeds of a crop. These combinations as described above may be applied to the locus of the weeds, in an herbicidally effective amount.

In an embodiment, the combinations or the compositions according to the present disclosure may be used for burndown application or fallow application.

In an embodiment, the method comprises applying the composition comprising L-glufosinate, salts, esters, or combinations thereof and at least one additional herbicide as a tank mix formulation.

In an embodiment, the method comprises applying the composition comprising L-glufosinate, salts, esters, or combinations thereof and at least one additional herbicide as a premix formulation.

In an embodiment, the method comprises applying the present combinations or compositions simultaneously, that is combined or individually, or in succession.

In an embodiment, the method comprises applying in immediate succession the combination comprising L-glufosinate, salts, esters, or combinations thereof and at least one additional herbicide.

In an embodiment, the compositions of the present disclosure may be applied in any known ways or conventional methods known to a person skilled in art. Non limiting examples of such methods comprise foliar spray, basal barking, stem injection, drill and fill method, axe cut method, cut stump, cut and swab, stem scraper, wick application, or combinations thereof. The compositions of the present disclosure are used in the customary manner, for example by watering, spraying, atomizing, dusting or scattering. Said compositions can be applied to a locus by the use of conventional ground sprayers, granule applicators, watering (drenching), drip irrigation, spraying, atomizing, broadcasting, dusting, foaming, spreading-on, aerial methods of spraying, aerial methods of application, methods utilizing application using modern technologies such as, but not limited to, drones, robots and by other conventional means known to those skilled in the art.

In some embodiments, wherein the undesirable and harmful vegetation is treated post-emergence, the compositions disclosed herein are applied by foliar application.

In accordance with present disclosure the method of control of target weeds may be carried out by spraying the suggested tank mixes, or the individual herbicides may be formulated as a kit-of-parts containing various components that may be mixed as instructed prior to spraying.

In an embodiment, the present disclosure provides a kit-of-parts comprising L-glufosinate, salts, esters, or combinations thereof and at least one additional herbicide. The kit-of-parts may additionally comprise a component comprising at least one agrochemically acceptable excipient. The kit-of-parts may additionally be accompanied with a set of instructions for mixing or use of the components provided therein.

According to an embodiment, the kit of parts comprises:
(a) L-glufosinate, salts, esters, or combinations thereof;
(b) at least one additional herbicide selected from the group comprising protoporphyrinogen oxidase inhibitor herbicide, acetyl CoA carboxylase inhibitor herbicide, auxin mimics herbicide, acetolactate synthase inhibitor herbicides, hydroxyphenyl pyruvate dioxygenase inhibitor herbicides, or combinations thereof; and
(c) at least one agrochemically acceptable excipient;
and optionally further comprises:
(d) instructions for use.

According to an embodiment, the kit of parts comprises:
(a) L-glufosinate ammonium;
(b) at least one additional herbicide selected from the group comprising protoporphyrinogen oxidase inhibitor herbicide, acetyl CoA carboxylase inhibitor herbicide, auxin mimics herbicide, acetolactate synthase inhibitor herbicides, hydroxyphenyl pyruvate dioxygenase inhibitor herbicides, or combinations thereof; and
(c) at least one agrochemically acceptable excipient;
and optionally further comprises:
(d) instructions for use.

In an embodiment, the present disclosure provides a method of increasing yield in a crop by application of a synergistic herbicidal combinations comprising L-glufosinate, salts, esters, or combinations and at least one additional herbicide, as described herein.

In an embodiment, the present disclosure provides a method of improving the plant health by application of a synergistic herbicidal combinations comprising L-glufosinate, salts, esters, or combinations and at least one additional herbicide, as described herein.

The herbicidal combinations/compositions of the present disclosure are highly safe to crop plants and capable of controlling target weeds causing problems in e.g., paddy fields, upland fields or non-agricultural fields over a wide range of pre-emergence to post-emergence weeds.

In view of the above, it will be seen that the several advantages of the disclosure are achieved, and other advantageous results are attained. Although the present disclosure has been disclosed in full, it will be understood that numerous additional modifications and variations could be made thereto without departing from the scope of the disclosure. The embodiments may be combined together for better understanding of the disclosure, without departing from the scope of the disclosure.

In another embodiment, alternative or multiple embodiments of the disclosure disclosed herein are not to be construed as limitations. Each embodiment can be referred to and claimed individually or in any combination with other embodiments of the disclosure. One or more embodiments of the disclosure can be combined together to exhibit the teaching of the invention, without departing from the scope of the disclosure.

The present disclosure is more particularly described in the following examples that are intended as illustration only, since numerous modifications and variations within the scope of the present disclosure will be apparent to those of skill in the art. The disclosure should therefore not be limited by the above-described embodiment, method, and following examples, but by all embodiments and methods within the scope and spirit of the disclosure.

The following examples illustrates the composition, underlying effect and basic methodology of the present disclosure.

### EXAMPLES

The following products were used for evaluating the weed control efficacy of present herbicidal combinations.

TABLE 6
Herbicidal products

| | Dose | Formulation | Dose |
|---|---|---|---|
| Active ingredient | (g ai/L) | Type | (g a.i./ha) |
| L-glufosinate ammonium | 280 | SL | 150 |
| (Glufosinate P-ammonium) | | | |
| Saflufenacil | 700 | WG | 30 |
| Triclopyr | 456 | SL | 228 |
| 2,4-D Choline | 480 | EC | 228 |
| Quizalofop-ethyl | 050 | EC | 25 |
| Quizalofop-p-tefuryl | 120 | EC | 25 |
| Mesotrione | 480 | SC | 100 |
| Imazapic + Imazapyr | 525 + 175 | WG | 31.5 + 10.5 |

### Evaluation of Post-Emergence Herbicidal Activity:

Methodology: Trials were carried out to evaluate the efficacy of the combinations comprising L-glufosinate ammonium and additional herbicides on Amaranthus genus weeds.

The soil used was sandy clay loam-sand: 68.0%; silt: 8.0%; clay: 24.0%.

All treatments were in 3 replications per treatment with a spray volume of 150 L/ha.

Efficacy Evaluation: The expected efficacy of the combination comprising L-glufosinate ammonium and additional herbicides was calculated using the well-established Colby method. Any difference between the observed and expected efficacy could be attributed to synergy exhibited by the combination.

In the Colby method, the expected (or predicted) response of a combination of herbicides is calculated by taking the product of the observed response for each individual component of the combination when applied alone, divided by 100, and subtracting this value from the sum of the observed response for each component when applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective (Colby, S. R., Weeds, 1967(15), p. 20-22). The Colby method requires only a single dose of each herbicide applied alone and the mixture of both doses. The formula used to calculate the expected efficacy (EE) which was compared with the observed efficacy (OE) to determine the efficacy of the present disclosure is explained herein:

The expected efficacy for a combination of two active ingredients is as follows:

$$EE = ( A + B - ( A \times B ) / 100 )$$

The expected efficacy for a combination of three active ingredients is as follows:

$$EE = A + B + C - ( A B + A C + BC ) / 100 + ABC / 10 , 000$$

wherein,
A=Observed efficacy of active ingredient A at the same concentration as used in the mixture.
B=Observed efficacy of the active ingredient B at the same concentration as used in the mixture.
C=Observed efficacy of the active ingredient C at the same concentration as used in the mixture.

### Example 1: Efficacy of Combination L-Glufosinate Ammonium and Saflufenacil on Amaranthus hybridus

Experiment was conducted to assess the efficacy of herbicidal combination comprising L-glufosinate ammonium (glufosinate-P-ammonium) and saflufenacil to control the weed, Amaranthus hybridus.

Table 7 demonstrates synergy in efficacy observed on the weed using the combination comprising L-glufosinate ammonium and saflufenacil. The percentage efficacy was calculated after 3 days of applications (DAA). The target weed was Amaranthus hybridus, and the concentration of the herbicide and the results are recorded in Table 7.

TABLE 7
Efficacy observed on Amaranthus hybridus

| | | | Expected | Observed |
|---|---|---|---|---|
| | | | Efficacy* | Efficacy |
| | Observed | | (%) of | (%) of |
| | efficacy | | L-glufosinate | L-glufosinate |
| | (%) of | | ammonium | ammonium |
| | L-glufosinate | Observed | (Glufosinate- | (Glufosinate- |
| | ammonium | efficacy | P-ammonium) + | P-ammonium) + |
| | (Glufosinate- | (%) of | Saflufenacil | Saflufenacil |
| Days after | P-ammonium) | Saflufenacil | (150 + | (150 + |
| application | (150 g | (30 g | 30 g | 30 g |
| (DAA) | a.i./ha) | a.i./ha) | a.i./ha) | a.i./ha) |
| 3 | 65 | 50 | 82.5 | 90 |

*Expected efficacy according to Colby's Formula

Therefore, synergy was observed in the control of weed Amaranthus hybridus by application of herbicidal combination comprising L-glufosinate ammonium and saflufenacil.

### Example 2: Efficacy of Combination L-Glufosinate Ammonium, Saflufenacil and Triclopyr on Amaranthus hybridus

Experiment was conducted to assess the efficacy of herbicidal combination comprising L-glufosinate ammonium, saflufenacil and triclopyr to control the weed Amaranthus hybridus.

Table 8 demonstrates synergy in efficacy observed on the weed using the combination comprising L-glufosinate ammonium, saflufenacil and triclopyr. The percentage efficacy was calculated after 3 DAA. The target weed was Amaranthus hybridus, and the concentration of the herbicide and the results are recorded in Table 8.

TABLE 8
Efficacy observed on Amaranthus hybridus

| | | | | Expected | Observed |
|---|---|---|---|---|---|
| | | | | Efficacy* | Efficacy |
| | | | | (%) of | (%) of |
| | | | | L-glufosinate | L-glufosinate |
| | Observed | | | ammonium + | ammonium + |
| | efficacy | Observed | Observed | Saflufenacil + | Saflufenacil + |
| | (%) of | efficacy | efficacy | Triclopyr | Triclopyr |
| | L-glufosinate | (%) of | (%) of | (150 + | (150 + |
| Days after | ammonium | Saflufenacil | Triclopyr | 30 + | 30 + |
| application | (150 g | (30 g | (228 g | 228 g | 228 g |
| (DAA) | a.i./ha) | a.i./ha) | a.i./ha) | a.i./ha) | a.i./ha) |
| 3 | 50 | 50 | 95 | 98.75 | 100 |

*Expected efficacy according to Colby's Formula

Therefore, synergy was observed in the control of weed Amaranthus hybridus by application of herbicidal combination comprising L-glufosinate ammonium, saflufenacil and triclopyr.

### Example 3: Efficacy of Combination L-Glufosinate Ammonium, Saflufenacil and 2,4-D Choline on Amaranthus hybridus

Experiment was conducted to assess the efficacy of herbicidal combination comprising L-glufosinate ammonium, saflufenacil and 2,4-D Choline to control the weed, Amaranthus hybridus.

Table 9 demonstrates synergy in efficacy observed on the weed using the combination comprising L-glufosinate ammonium, saflufenacil and 2,4-D Choline. The percentage efficacy was calculated after 3 DAA. The target weed was Amaranthus hybridus, and the concentration of the herbicide and the results are recorded in Table 9.

TABLE 9
Efficacy observed on Amaranthus hybridus

| | | | | Expected | Observed |
|---|---|---|---|---|---|
| | | | | Efficacy* | Efficacy |
| | | | | (%) of | (%) of |
| | | | | L-glufosinate | L-glufosinate |
| | | | | ammonium + | ammonium + |
| | Observed | | Observed | Saflufenacil + | Saflufenacil + |
| | efficacy | Observed | efficacy | 2,4-D | 2,4-D |
| | (%) of | efficacy | (%) of | Choline | Choline |
| | L-glufosinate | (%) of | 2,4-D | (150 + | (150 + |
| Days after | ammonium | Saflufenacil | Choline | 30 + | 30 + |
| application | (150 g | (30 g | (228 g | 228 g | 228 g |
| (DAA) | a.i./ha) | a.i./ha) | a.i./ha) | a.i./ha) | a.i./ha) |
| 3 DAA | 50 | 50 | 95 | 98.75 | 100 |

*Expected efficacy according to Colby's Formula

### Example 4: Efficacy of Combination L-Glufosinate Ammonium and Quizalofop-Ethyl on Amaranthus hybridus

Experiment was conducted to assess the efficacy of herbicidal combination comprising L-glufosinate ammonium and quizalofop-ethyl to control the weed, Amaranthus hybridus.

Table 10 demonstrates synergy in efficacy observed on the weed using the combination comprising L-glufosinate ammonium and quizalofop-ethyl. The percentage efficacy was calculated after 3 DAA and 14 DAA. The target weed was Amaranthus hybridus, and the concentration of the herbicide and the results are recorded in Table 10.

TABLE 10
Efficacy observed on Amaranthus hybridus

| | | | Expected | Observed |
|---|---|---|---|---|
| | | | Efficacy* | Efficacy |
| | | | (%) of | (%) of |
| | Observed | Observed | L-glufosinate | L-glufosinate |
| | efficacy | efficacy | ammonium + | ammonium + |
| | (%) of | (%) of | quizalofop- | quizalofop- |
| | L-glufosinate | quizalofop- | ethyl | ethyl |
| Days after | ammonium | ethyl | (150 + | (150 + |
| application | (150 g | (25 g | 25 g | 25 g |
| (DAA) | a.i./ha) | a.i./ha) | a.i./ha) | a.i./ha) |
| 3 DAA | 50 | 0 | 50 | 51 |
| 14 DAA | 60 | 0 | 60 | 65 |

*Expected efficacy according to Colby's Formula

### Example 5: Efficacy of Combination L-Glufosinate Ammonium and Quizalofop-p-Tefuryl on Amaranthus hybridus

Experiment was conducted to assess the efficacy of herbicidal combination comprising L-glufosinate ammonium and quizalofop-p-tefuryl to control the weed, Amaranthus hybridus

Table 11 demonstrates synergy in efficacy observed on the weed using the combination comprising L-glufosinate ammonium and quizalofop-p-tefuryl. The percentage efficacy was calculated after 3 DAA and 14 DAA. The target weed was Amaranthus hybridus, and the concentration of the herbicide and the results are recorded in Table 11.

TABLE 11
Efficacy observed on Amaranthus hybridus

| | | | Expected | Observed |
|---|---|---|---|---|
| | | | Efficacy* | Efficacy |
| | | | (%) of | (%) of |
| | Observed | Observed | L-glufosinate | L-glufosinate |
| | efficacy | efficacy | ammonium + | ammonium + |
| | (%) of | (%) of | quizalofop- | quizalofop- |
| | L-glufosinate | quizalofop- | p-tefuryl | p-tefuryl |
| Days after | ammonium | p-tefuryl | (150 + | (150 + |
| application | (150 g | (25 g | 25 g | 25 g |
| (DAA) | a.i./ha) | a.i./ha) | a.i./ha) | a.i./ha) |
| 3 DAA | 50 | 0 | 50 | 51 |
| 14 DAA | 60 | 0 | 60 | 81 |

*Expected efficacy according to Colby's Formula

### Example 6: Efficacy of Combination L-Glufosinate Ammonium and Mesotrione on Amaranthus viridis

Experiment was conducted to assess the efficacy of herbicidal combination comprising L-glufosinate ammonium and Mesotrione to control the weed, Amaranthus viridis.

Table 12 demonstrates synergy in efficacy observed on the weed using the combination comprising L-glufosinate ammonium and Mesotrione. The percentage efficacy was calculated after 3 DAA and 7 DAA. The target weed was Amaranthus viridis, and the concentration of the herbicide and the results are recorded in Table 12.

TABLE 12
Efficacy observed on Amaranthus viridis

| | | | Expected | Observed |
|---|---|---|---|---|
| | | | Efficacy* | Efficacy |
| | Observed | | (%) of | (%) of |
| | efficacy | Observed | L-glufosinate | L-glufosinate |
| | (%) of | efficacy | ammonium + | ammonium + |
| | L-glufosinate | (%) of | Mesotrione | Mesotrione |
| Days after | ammonium | Mesotrione | (150 + | (150 + |
| application | (150 g | (100 g | 100 g | 100 g |
| (DAA) | a.i./ha) | a.i./ha) | a.i./ha) | a.i./ha) |
| 3 DAA | 40 | 10 | 46 | 70 |
| 7 DAA | 80 | 30 | 86 | 95 |

*Expected efficacy according to Colby's Formula

### Example 7: Efficacy of Combination L-Glufosinate Ammonium Imazapic and Imazapyr on Amaranthus viridis

Experiment was conducted to assess the efficacy of herbicidal combination comprising L-glufosinate ammonium, Imazapic and Imazapyr to control the weed, Amaranthus viridis.

Table 13 demonstrates synergy in efficacy observed on the weed using the combination comprising L-glufosinate ammonium, Imazapic and Imazapyr. The percentage efficacy was calculated after 3 DAA. The target weed was Amaranthus viridis, and the concentration of the herbicide and the results are recorded in Table 13.

TABLE 13
Efficacy observed on Amaranthus viridis

| | | | Expected | Observed |
|---|---|---|---|---|
| | | | Efficacy* | Efficacy |
| | | Observed | (%) of | (%) of |
| | | efficacy | L-glufosinate | L-glufosinate |
| | Observed | (%) of | ammonium + | ammonium + |
| | efficacy | LGF + | LGF + | LGF + |
| | (%) of | Imazapic + | Imazapic + | Imazapic + |
| | L-glufosinate | Imazapyr | Imazapyr | Imazapyr |
| Days after | ammonium | (525 + | (525 + | (525 + |
| application | (150 g | 175 g | 175 g | 175 g |
| (DAA) | a.i./ha) | a.i./ha) | a.i./ha) | a.i./ha) |
| 3 DAA | 50 | 35 | 67.5 | 70 |

*Expected efficacy according to Colby's Formula

Therefore, the results represented in Examples in Tables 7 to 13 clearly demonstrate synergy between L-glufosinate ammonium and additional herbicide(s). The difference between the observed efficacy and the expected efficacy clearly demonstrates the synergistic effect of the herbicidal combination.

We claim:

1. A method for controlling weeds by applying a herbicidal combination comprising:
(a) L-glufosinate, salts, esters, or combinations thereof; and
(b) at least one additional herbicide selected from the group comprising protoporphyrinogen oxidase inhibitor herbicides; acetyl CoA carboxylase inhibitor herbicides; auxin mimics herbicides; acetolactate synthase inhibitor herbicides; hydroxyphenyl pyruvate dioxygenase inhibitor herbicides; or combinations thereof;
wherein the weeds comprise Amaranthus genus weeds.

2. The method as claimed in claim 1, wherein the salt of L-glufosinate is selected from the group comprising L-glufosinate sodium, L-glufosinate potassium, L-glufosinate ammonium, or combinations thereof.

3. The method as claimed in claim 1, wherein the combination comprises:
(a) L-glufosinate, salts, esters, or combinations thereof; and
(b) at least one protoporphyrinogen oxidase inhibitor herbicide.

4. The method as claimed in claim 3, wherein the combination further comprises at least one auxin mimics herbicide.

5. The method as claimed in claim 1, wherein the combination comprises:
(a) L-glufosinate, salts, esters, or combinations thereof; and
(b) at least one acetyl CoA carboxylase inhibitor herbicide.

6. The method as claimed in claim 1, wherein the combination comprises:
(a) L-glufosinate, salts, esters, or combinations thereof; and
(b) at least one acetolactate synthase inhibitor herbicide.

7. The method as claimed in claim 1, wherein the combination comprises:
(a) L-glufosinate, salts, esters, or combinations thereof; and
(b) at least one hydroxyphenyl pyruvate dioxygenase inhibitor herbicide.

8. The method as claimed in claim 1, wherein
(a) the protoporphyrinogen oxidase inhibitor herbicide is saflufenacil;
(b) the acetyl CoA carboxylase inhibitor herbicide is selected from the group comprising quizalofop-ethyl, quizalofop-p-tefuryl, or combinations thereof;
(c) the auxin mimics herbicide is selected from the group comprising 2,4-D choline, triclopyr, or combinations thereof;
(d) the acetolactate synthase inhibitor herbicide is selected from the group comprising imazapic, imazapyr, or combinations thereof; and
(e) the hydroxyphenyl pyruvate dioxygenase inhibitor herbicide is mesotrione.

9. The method as claimed in claim 1, wherein a weight ratio of L-glufosinate, salts, esters, or combinations thereof to the additional herbicide is in a range from about 1:25 to about 25:1.

10. The method as claimed in claim 1, wherein a weight ratio of L-glufosinate, salts, esters, or combinations thereof, protoporphyrinogen oxidase inhibitor herbicides, and auxin class mimics herbicide is in a range from about 1:100:100 to about 100:1:1.

11. The method as claimed in claim 1, wherein the amount of L-glufosinate, salts, esters, or combinations thereof is in a range from about 100 g a.i./L to about 400 g a.i./L.

12. The method as claimed in claim 1, wherein
(a) the protoporphyrinogen oxidase inhibitor herbicide is in a range from about 300 g a.i./L to about 1200 g a.i./L;
(b) the acetyl CoA carboxylase inhibitor herbicide is in a range from about 5 g a.i./L to about 200 g a.i./L;
(c) the auxin mimics herbicide is in a range from about 100 g a.i./L to about 1000 g a.i./L;
(d) the acetolactate synthase inhibitor herbicide is in a range from about 100 g a.i./L to about 1100 g a.i./L; and
(e) the hydroxyphenyl pyruvate dioxygenase inhibitor herbicide is in a range from about 250 g a.i./L to about 750 g a.i./L.

13. The method as claimed in claim 1, wherein the L-glufosinate, salts, esters, or combinations thereof is applied at an application rate from about 50 g a.i./ha to about 350 g a.i./ha.

14. The method as claimed in claim 1, wherein
(a) the protoporphyrinogen oxidase inhibitor herbicide is applied at an application rate from about 5 g a.i./ha to about 200 g a.i./ha;
(b) the acetyl CoA carboxylase inhibitor herbicide is applied at an application rate from about 5 g a.i./ha to about 200 g a.i./ha;
(c) the auxin mimics herbicide is applied at an application rate from about 50 g a.i./ha to about 600 g a.i./ha;
(d) the acetolactate synthase inhibitor herbicide is applied at an application rate from about 5 g a.i./ha to about 100 g a.i./ha; and
(e) the hydroxyphenyl pyruvate dioxygenase inhibitor herbicide is applied at an application rate from about 10 g a.i./ha to about 400 g a.i./ha.

15. The method as claimed in claim 1, wherein the Amaranthus genus weeds comprise Amaranthus acanthochiton, Amaranthus acutilobus, Amaranthus albus, Amaranthus anderssonii, Amaranthus arenicola, Amaranthus australis, Amaranthus bigelovii, Amaranthus blitoides, Amaranthus blitum, Amaranthus brownie, Amaranthus californicus, Amaranthus cannabinus, Amaranthus caudatus, Amaranthus chihuahuensis, Amaranthus crassipes, Amaranthus crispus, Amaranthus cruentus, Amaranthus deflexus, Amaranthus dubius, Amaranthus fimbriatus, Amaranthus floridanus, Amaranthus furcatus, Amaranthus graecizans, Amaranthus grandifloras, Amaranthus greggii, Amaranthus hybridus, Amaranthus hypochondriacus, Amaranthus interruptus, Amaranthus minimus, Amaranthus mitchellii, Amaranthus muricatus, Amaranthus obcordatus, Amaranthus palmeri, Amaranthus polygonoides, Amaranthus powellii, Amaranthus pringlei, Amaranthus pumilus, Amaranthus quitensis, Amaranthus retroflexus, Amaranthus saradhiana, Amaranthus scleranthoides, Amaranthus scleropoides, Amaranthus spinosus, Amaranthus standleyanus, Amaranthus thunbergia, Amaranthus torreyi, Amaranthus tricolor, Amaranthus tuberculatus, Amaranthus viridis, Amaranthus watsonii, Amaranthus wrightii, or combinations thereof.

16. The method as claimed in claim 1, wherein the combination provides from about 50% to about 100% control of the weeds.

17. A herbicidal combination comprising:
(a) L-glufosinate, salts, esters, or combinations thereof;
(b) at least one additional herbicide selected from the group comprising protoporphyrinogen oxidase inhibitor herbicide, or combinations thereof;
or
(c) at least two additional herbicides selected from the group comprising acetolactate synthase inhibitor herbicide.

18. The combination as claimed in claim 17, wherein the combination further comprises at least one additional herbicide selected from the group comprising auxin mimics herbicide, or combinations thereof.

19. A herbicidal composition for controlling Amaranthus genus weeds, the composition comprising:
(a) L-glufosinate, salts, esters, or combinations thereof;
(b) at least one additional herbicide selected from the group comprising protoporphyrinogen oxidase inhibitor herbicides; acetyl CoA carboxylase inhibitor herbicides; auxin mimics herbicides; acetolactate synthase inhibitor herbicides; hydroxyphenyl pyruvate dioxygenase inhibitor herbicides; or combinations thereof; and
(c) at least one agrochemically acceptable excipient.
